(19) United States
(12) Patent Application Publication
(10) Pub. No.: US 2017/0254645 A1
(43) Pub. Date: Sep. 7, 2017

(54) ANGULAR VELOCITY DETECTION CIRCUIT, ANGULAR VELOCITY DETECTION DEVICE, ELECTRONIC APPARATUS, AND MOVING OBJECT

(71) Applicant: Seiko Epson Corporation, Tokyo (JP)

(72) Inventor: Kei KANEMOTO, Fujimi (JP)

(21) Appl. No.: 15/440,466

(22) Filed: Feb. 23, 2017

(30) Foreign Application Priority Data
Mar. 4, 2016 (JP) 2016-042346

(51) Int. Cl. G01C 19/5776; G01C 19/5712

(52) U.S. Cl. CPC G01C 19/5776; G01C 19/5712

(57) ABSTRACT

An angular velocity detection circuit includes: a first conversion unit that includes a first operational amplifier, and converts a first detection signal, which is output from a first detection electrode and is input to a first input terminal of the first operational amplifier, into a voltage; an angular velocity signal generation unit that generates an angular velocity signal on the basis of an output signal of the first conversion unit; and a first correction signal generation unit that generates a first correction signal for reducing an offset of the angular velocity signal which occurs due to a leakage signal included in the first detection signal on the basis of a signal based on drive oscillation of the angular velocity detection element. The first correction signal is input to the first input terminal or a second input terminal of the first operational amplifier directly or through a resistor.

### BACKGROUND

1. Technical Field

The present invention relates to an angular velocity detection circuit, an angular velocity detection device, an electronic apparatus, and a moving object.

2. Related Art

Recently, for example, an angular velocity sensor (gyro sensor), which detects an angular velocity by using a silicon micro electromechanical system (MEMS) technology, has been developed.

U.S. Patent Application Publication No. 2007/0180908 discloses a technology of inputting a quadrature error cancel signal on a front stage side (between a detection mass unit and a C/V conversion circuit) of a detection circuit with capacitive coupling to reduce a quadrature signal that is included in an output signal of the detection mass unit.

However, in the gyro sensor described in US Unexamined Patent Application Publication No. 2007/0180908, when the capacitive coupling is made at the front stage of the detection circuit, a noise component, which is included in a signal that is input to the detection circuit, increases, and thus there is a problem that it is difficult to improve S/N of an angular velocity signal that is output.

### SUMMARY

An advantage of some aspects of the invention is to provide an angular velocity detection circuit and an angular velocity detection device which are capable of further improving S/N of an angular velocity signal in comparison to the related art. Another advantage of some aspects of the invention is to provide an electronic apparatus and a moving object which use the angular velocity detection device.

The invention can be realized in the following aspects or application examples.

### APPLICATION EXAMPLE 1

According to this application example, there is provided an angular velocity detection circuit including: a first conversion unit that includes a first operational amplifier, and converts a first detection signal, which is output from a first detection electrode of an angular velocity detection element and is input to a first input terminal of the first operational amplifier, into a voltage; an angular velocity signal generation unit that generates an angular velocity signal on the basis of an output signal of the first conversion unit; and a first correction signal generation unit that generates a first correction signal for reducing an offset of the angular velocity signal which occurs due to a leakage signal that is included in the first detection signal on the basis of a signal based on drive oscillation of the angular velocity detection element. The first correction signal is input to the first input terminal or a second input terminal of the first operational amplifier directly or through a resistor.

For example, the first conversion unit may be a Q/V converter (charge amplifier) that converts a charge into a voltage, or an I/V converter that converts a current into a voltage.

According to the angular velocity detection circuit according to this application example, the first correction signal is input to the first input terminal or the second input terminal of the first operational amplifier, and thus it is possible to reduce the offset of the angular velocity signal which occurs due to the leakage signal that is included in the first detection signal. In addition, the first correction signal is input to the first input terminal or the second input terminal of the first operational amplifier directly or through a resistor, and thus it is possible to further reduce a noise component included in the output signal of the first conversion unit in comparison to the related art in which the correction signal is input through a capacitor. In addition, the first correction signal is input to the first input terminal or the second input terminal of the first operational amplifier, and thus a leakage signal is attenuated in the output signal of the first conversion unit in proportional to the attenuation. Accordingly, it is possible to enlarge a gain of the first conversion unit. Accordingly, according to the angular velocity detection circuit according to this application example, a ratio of an angular velocity component (Coriolis signal) and a noise component, which are included in the output signal of the first conversion unit, increases. As a result, it is possible to further improve S/N of the angular velocity signal that is generated on the basis of the output signal of the first conversion unit in comparison to the related art.

### APPLICATION EXAMPLE 2

In the angular velocity detection circuit according to the application example, the first correction signal generation unit may include a first amplitude adjustment unit that adjusts an amplitude of the first correction signal.

According to the angular velocity detection circuit according to this application example, the first correction signal, of which the amplitude is adjusted by the first amplitude adjustment unit, is input to the first input terminal or the second input terminal of the first operational amplifier, and thus the leakage signal in the output signal of the first conversion unit is further attenuated. As a result, it is possible to further improve S/N of the angular velocity signal.

### APPLICATION EXAMPLE 3

In the angular velocity detection circuit according to the application example, the first correction signal generation unit may include a first synchronous detection circuit that detects a level of the leakage signal included in the first detection signal on the basis of an output signal of the first conversion unit, and the first amplitude adjustment unit may adjust the amplitude of the first correction signal on the basis of the level of the leakage signal which is detected by the first synchronous detection circuit.

According to the angular velocity detection circuit according to this application example, even when the amplitude of the leakage signal included in the first detection signal varies, the amplitude of the first correction signal is adjusted in conformity to the variation. Accordingly, even when an environment varies, it is possible to constantly maintain S/N of the angular velocity signal.

In addition, according to the angular velocity detection circuit according to this application example, in a process of manufacturing the angular velocity detection circuit, it is not necessary to inspect the amplitude of the leakage signal included in the first detection signal to set information for adjusting the amplitude of the first correction signal. Accordingly, it is also possible to reduce the manufacturing cost.

### APPLICATION EXAMPLE 4

In the angular velocity detection circuit according the application example, the first amplitude adjustment unit may adjust the amplitude of the first correction signal on the basis of information that is stored in a storage unit.

According to the angular velocity detection circuit according to this application example, for example, in a process of manufacturing the angular velocity detection circuit, in a case where the amplitude of the leakage signal included in the first detection signal is inspected, and information corresponding to the amplitude of the leakage signal is stored in the storage unit, it is possible to improve S/N of the angular velocity signal.

In addition, according to the angular velocity detection circuit according to this application example, since an amplitude or a phase of the leakage signal included in the first detection signal varies due to an environmental variation, an amplitude or a phase of a signal based on drive oscillation of the angular velocity detection element also varies in the same manner, even when a level of the leakage signal is not detected, it is possible to constantly maintain S/N of the angular velocity signal to a certain extent. Accordingly, according to the angular velocity detection circuit according to this application example, a circuit, which detects the level of the leakage signal included in the first detection signal, is not necessary, and thus it is also possible to reduce a circuit area.

### APPLICATION EXAMPLE 5

In the angular velocity detection circuit according to the application example, phases of the first correction signal, and a Coriolis signal included in the first detection signal may deviate from each other by 90°.

According to the angular velocity detection circuit according to this application example, it is possible to effectively attenuate a mechanical oscillation leakage signal of which a phase deviates from a phase of the Coriolis signal by 90° due to the first correction signal, and thus it is possible to improve S/N of the angular velocity signal.

### APPLICATION EXAMPLE 6

In the angular velocity detection circuit according to the application example, the first correction signal generation unit may include a first phase adjustment unit that adjusts a phase of the first correction signal.

According to the angular velocity detection circuit according to this application example, the first correction signal, of which a phase is adjusted by the first phase adjustment unit, is input to the first input terminal or the second input terminal of the first operational amplifier, and thus the leakage signal in the output signal of the first conversion unit is further attenuated. As a result, it is possible to further improve S/N of the angular velocity signal.

### APPLICATION EXAMPLE 7

In the angular velocity detection circuit according to the application example, the first correction signal generation unit may include a first synchronous detection circuit that detects a level of the leakage signal included in the first detection signal on the basis of an output signal of the first conversion unit, and the first phase adjustment unit may adjust a phase of the first correction signal on the basis of the level of the leakage signal which is detected by the first synchronous detection circuit.

According to the angular velocity detection circuit according to this application example, even when a phase of the leakage signal included in the first detection signal varies, the phase of the first correction signal is adjusted in conformity to the variation. Accordingly, even when an environment varies, it is possible to constantly maintain S/N of the angular velocity signal.

In addition, according to the angular velocity detection circuit according to this application example, in a process of manufacturing the angular velocity detection circuit, it is not necessary to inspect the phase of the leakage signal included in the first detection signal to set information for adjusting the phase of the first correction signal. Accordingly, it is also possible to reduce the manufacturing cost.

### APPLICATION EXAMPLE 8

In the angular velocity detection circuit according to the application example, the first phase adjustment unit may adjust the phase of the first correction signal on the basis of information that is stored in a storage unit.

According to the angular velocity detection circuit according to this application example, in a process of manufacturing the angular velocity detection circuit, in a case where the phase of leakage signal included in the first detection signal is inspected, and information corresponding to the phase of the leakage signal is stored in the storage unit, it is possible to improve S/N of the angular velocity signal.

In addition, according to the angular velocity detection circuit according to this application example, when an amplitude or a phase of the leakage signal included in the first detection signal varies due to an environmental variation, an amplitude or a phase of a signal based on drive oscillation of the angular velocity detection element also varies in the same manner, even when a level of the leakage signal is not detected, it is possible to constantly maintain S/N of the angular velocity signal to a certain extent. Accordingly, according to the angular velocity detection circuit according to this application example, a circuit, which detects the level of the leakage signal included in the first detection signal, is not necessary, and thus it is also possible to reduce a circuit area.

### APPLICATION EXAMPLE 9

The angular velocity detection circuit according to the application example may further include: a second conversion unit that includes a second operational amplifier, and converts a second detection signal, which is output from a second detection electrode of the angular velocity detection element and is input to a first input terminal of the second operational amplifier, into a voltage; and a second correction signal generation unit that generates a second correction signal for reducing an offset of the angular velocity signal which occurs due to a leakage signal that is included in the second detection signal on the basis of a signal based on the drive oscillation. The second correction signal may be input to the first input terminal or a second input terminal of the second operational amplifier directly or through a resistor, and the angular velocity signal generation unit may include a differential amplifier unit that differentially amplifies an output signal of the first conversion unit and an output signal of the second conversion unit, and generates the angular velocity signal on the basis of an output signal of the differential amplifier unit.

For example, the second conversion unit may be a Q/V converter (charge amplifier) that converts a charge into a voltage, or an I/V converter that converts a current into a voltage.

According to the angular velocity detection circuit according to this application example, the first correction signal is input to the first input terminal or the second input terminal of the first operational amplifier, and the second correction signal is input to the first input terminal or the second input terminal of the second operational amplifier, and thus it is possible to reduce an offset of the angular velocity signal which occurs due to the leakage signal that is included in the first detection signal and the second detection signal. In addition, the first correction signal is input to the first input terminal or the second input terminal of the first operational amplifier directly or through the resistor, and the second correction signal is input to the first input terminal or the second input terminal of the second operational amplifier directly or through the resistor. Accordingly, it is possible to further reduce a noise component that is included in the output signal of the first conversion unit and the output signal of the second conversion unit in comparison to the related art in which the correction signal is input through a capacitor. In addition, the first correction signal is input to the first input terminal or the second input terminal of the first operational amplifier, and the second correction signal is input to the first input terminal or the second input terminal of the second operational amplifier, and thus a leakage signal is attenuated in the output signal of the first conversion unit and the output signal of the second conversion unit. Accordingly, it is possible to enlarge a gain of the first conversion unit and the second conversion unit in proportional to the attenuation. Accordingly, according to the angular velocity detection circuit according to this application example, a ratio of an angular velocity component (Coriolis signal) and a noise component, which are included in the output signal of the first conversion unit and the output signal of the second conversion unit, increases. As a result, it is possible to further improve S/N of the angular velocity signal that is generated on the basis of a signal, which is obtained from differential amplification of the output signal of the first conversion unit and the output signal of the second conversion unit in comparison to the related art.

The second correction signal generation unit may include a second amplitude adjustment unit that adjusts an amplitude of the second correction signal. The second correction signal generation unit may include a second synchronous detection circuit that detects a level of the leakage signal included in the second detection signal on the basis of an output signal of the second conversion unit, and the second amplitude adjustment unit may adjust the amplitude of the second correction signal on the basis of the level of the leakage signal which is detected by the second synchronous detection circuit. The second amplitude adjustment unit may adjust the amplitude of the second correction signal on the basis of information that is stored in a storage unit. Phases of the second correction signal and a Coriolis signal included in the second detection signal may deviate from each other by 90°. The second correction signal generation unit may include a second phase adjustment unit that adjusts a phase of the second correction signal. The second correction signal generation unit may include a second synchronous detection circuit that detects a level of the leakage signal included in the second detection signal on the basis of an output signal of the second conversion unit, and the second phase adjustment unit may adjust a phase of the second correction signal on the basis of the level of the leakage signal which is detected by the second synchronous detection circuit. The second phase adjustment unit may adjust the phase of the second correction signal on the basis of information that is stored in a storage unit.

### APPLICATION EXAMPLE 10

According to this application example, there is provided an angular velocity detection device including: any one of the angular velocity detection circuits, a drive circuit that drives the angular velocity detection element, and the angular velocity detection element.

According to the angular velocity detection device according to this application example, any one of the angular velocity detection circuit is provided, and thus it is possible to further improve S/N of the angular velocity signal in comparison to the related art.

### APPLICATION EXAMPLE 11

According to this application example, there is provided an electronic apparatus including the angular velocity detection device.

### APPLICATION EXAMPLE 12

According to this application example, there is provided a moving object including the angular velocity detection device.

According to these application examples, the angular velocity detection device, which is capable of further improving S/N of the angular velocity signal in comparison to the related art, is provided, and thus it is also possible to realize the electronic apparatus and the moving object which are capable of performing processing, for example, based on the variation in the angular velocity with higher accuracy.

### BRIEF DESCRIPTION OF THE DRAWINGS

The invention will be described with reference to the accompanying drawings, wherein like numbers reference like elements.

FIG. 1 is a plan view schematically illustrating an angular velocity detection element.

FIG. 2 is a cross-sectional view schematically illustrating the angular velocity detection element.

FIG. 3 is a view illustrating an operation of the angular velocity detection element.

FIG. 4 is a view illustrating an operation of the angular velocity detection element.

FIG. 5 is a view illustrating an operation of the angular velocity detection element.

FIG. 6 is a view illustrating an operation of the angular velocity detection element.

FIG. 7 is a view illustrating a configuration of an angular velocity detection device according to a first embodiment.

FIG. 8 is a view illustrating an example of a signal waveform in the angular velocity detection device according to the first embodiment.

FIG. 9 is a view illustrating a configuration of an angular velocity detection device according to a second embodiment.

FIG. 10 is a view illustrating an example of a signal waveform in the angular velocity detection device according to the second embodiment.

FIG. 11 is a view illustrating a configuration of an angular velocity detection device according to a third embodiment.

FIG. 12 is a view illustrating a configuration of an angular velocity detection device according to a fourth embodiment.

FIG. 13 is a view illustrating a configuration of an angular velocity detection device according to Modification Example 1.

FIG. 14 is a view illustrating a configuration of an angular velocity detection device according to Modification Example 2.

FIG. 15 is a functional block diagram of an electronic apparatus according to this embodiment.

FIG. 16A is a view illustrating an example of an external appearance of a smart phone that is an example of the electronic apparatus.

FIG. 16B is a view illustrating an example of an external appearance of an arm-mounted portable apparatus that is an example of the electronic apparatus.

FIG. 17 is a view (top view) illustrating an example of a moving object of this embodiment.

### DESCRIPTION OF EXEMPLARY EMBODIMENTS

Hereinafter, preferred embodiments of the invention will be described in detail with reference to the accompanying drawings. Furthermore, the following embodiments are not intended to limit the contents of the invention which are described in claims. In addition, it cannot be said that the entirety of configurations to be described below are essential configuration elements of the invention.

### 1. ANGULAR VELOCITY DETECTION DEVICE

### 1-1. First Embodiment

Configuration and Operation of Angular Velocity Detection Element

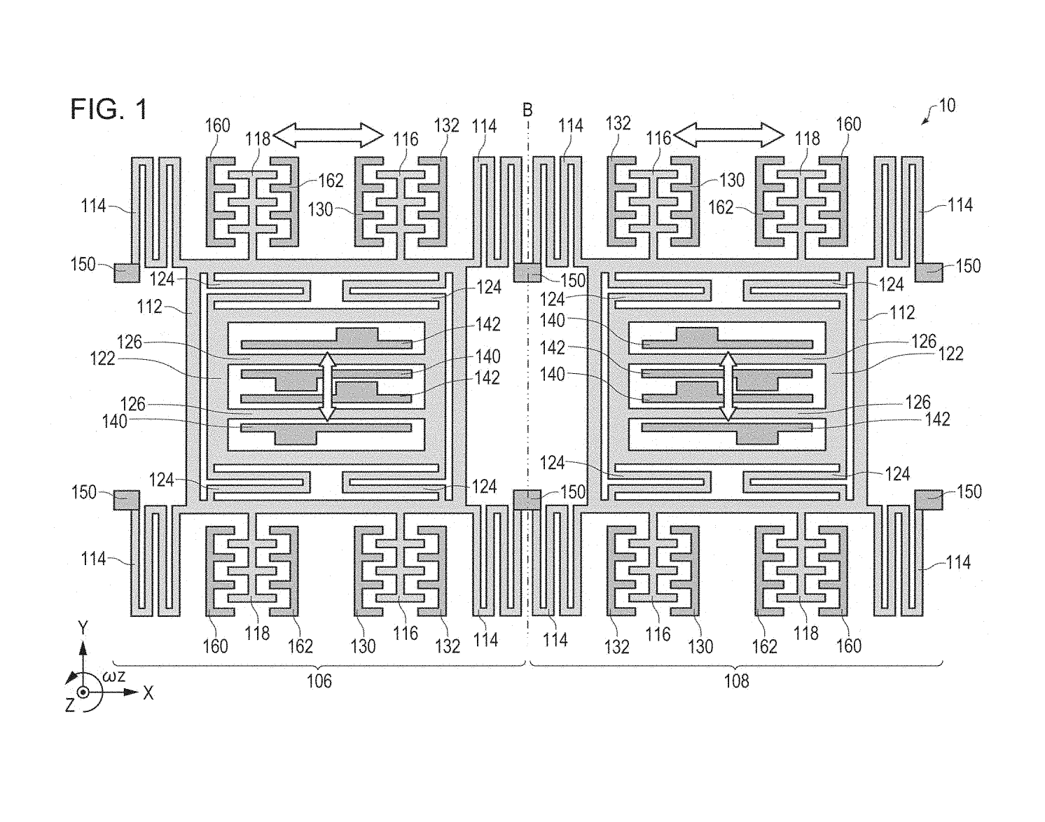

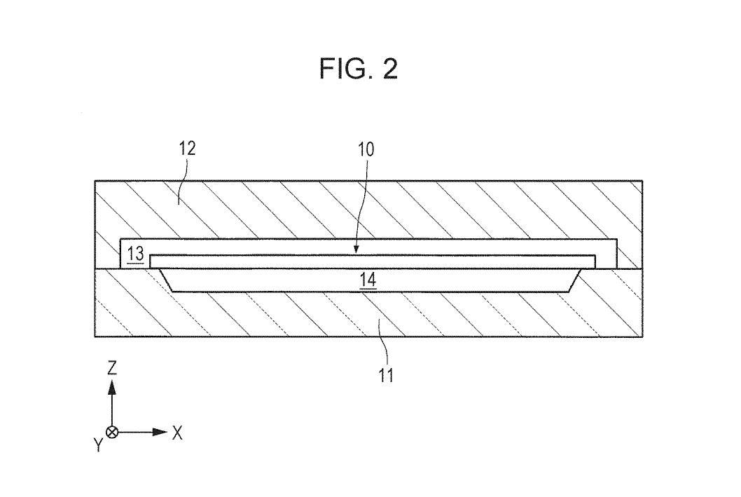

First, description will be given of an angular velocity detection element 10 that is included in an angular velocity detection device 1 according to this embodiment with reference to the accompanying drawings. FIG. 1 is a plan view schematically illustrating the angular velocity detection element 10. FIG. 2 is a cross-sectional view schematically illustrating the angular velocity detection element 10. Furthermore, in FIG. 1, an X-axis, a Y-axis, and a Z-axis are illustrated as three axes perpendicular to each other. Hereinafter, description will be given of an example in which the angular velocity detection element 10 is an electrostatic capacitive MEMS element that detects an angular velocity of Z-axis rotation.

As illustrated in FIG. 2, the angular velocity detection element 10 is provided on a substrate 11, and is accommodated in an accommodation portion that is constituted by the substrate 11 and a lid 12. For example, a cavity 13, which is an inner space of the accommodation portion, is evacuated and is hermetically closed. Examples of a material of the substrate 11 include glass and silicon. Examples of a material of the lid 12 include silicon and glass.

As illustrated in FIG. 1, the angular velocity detection element 10 includes an oscillating body 112, a stationary drive electrode 130, a stationary drive electrode 132, a movable drive electrode 116, a stationary monitor electrode 160, a stationary monitor electrode 162, a movable monitor electrode 118, a stationary detection electrode 140, a stationary detection electrode 142, and a movable detection electrode 126.

As illustrated in FIG. 1, the angular velocity detection element 10 includes a first structure body 106 and a second structure body 108. The first structure body 106 and the second structure body 108 are connected to each other along the X-axis. The first structure body 106 is located on a −X direction side in comparison to the second structure body 108. For example, the structure bodies 106 and 108 have shapes symmetrical to a boundary line B (straight line along the Y-axis) thereof. Furthermore, although not illustrated, the angular velocity detection element 10 may be constituted by the first structure body 106 without being provided with the second structure body 108.

Each of the structure bodies 106 and 108 includes the oscillating body 112, a first spring unit 114, the movable drive electrode 116, a displacement unit 122, a second spring unit 124, the stationary drive electrodes 130 and 132, movable oscillation detection electrodes 118 and 126, stationary oscillation detection electrodes 140, 142, 160, and 162, and a fixing unit 150. The movable oscillation detection electrodes 118 and 126 are classified into the movable monitor electrode 118 and the movable detection electrode 126. The stationary oscillation detection electrodes 140, 142, 160, and 162 are classified into the stationary detection electrodes 140 and 142, and the stationary monitor electrodes 160 and 162.

For example, the oscillating body 112, the spring units 114 and 124, the movable drive electrode 116, the movable monitor electrode 118, the displacement unit 122, the movable detection electrode 126, and the fixing unit 150 are integrally formed by processing a silicon substrate (not illustrated) that is bonded to the substrate 11. According to this, a minute processing technology, which is used in manufacturing of a silicon semiconductor device, is applicable, and thus it is possible to realize miniaturization of the angular velocity detection element 10. Examples of a material of the angular velocity detection element 10 include silicon to which conductivity is applied through doping with an impurity such as phosphorus and boron. Furthermore, the movable drive electrode 116, the movable monitor electrode 118, and the movable detection electrode 126 may be provided on a surface of the oscillating body 112 and the like as a separate member from the oscillating body 112.

For example, the oscillating body 112 has a frame shape. The displacement unit 122, the movable detection electrode 126, and the stationary detection electrodes 140 and 142 are provided on an inner side of the oscillating body 112.

One end of the first spring unit 114 is connected to the oscillating body 112, and the other end thereof is connected to the fixing unit 150. The fixing unit 150 is fixed onto the substrate 11. That is, the concave portion (refer to FIG. 2) is not provided on a lower side of the fixing unit 150. The oscillating body 112 is supported by the fixing unit 150 through the first spring unit 114. In the example illustrated in the drawing, the first spring unit 114 is provided in a number of four in each of the first structure body 106 and the second structure body 108. Furthermore, the fixing unit 150 on a boundary line B between the first structure body 106 and the second structure body 108 may not be provided.

The first spring unit 114 has a configuration capable of displacing the oscillating body 112 in the X-axis direction. More specifically, the first spring unit 114 has a shape that extends in the X-axis direction (along the X-axis) while reciprocating in the Y-axis direction (along the Y-axis). Furthermore, the number of the first spring unit 114 is not particularly limited as long as the first spring unit 114 can allow the oscillating body 112 to oscillate along the X-axis.

The movable drive electrode 116 is connected to the oscillating body 112. The movable drive electrode 116 extends from the oscillating body 112 in a +Y direction and a −Y direction. A plurality of the movable drive electrodes 116 may be provided, and the plurality of movable drive electrodes 116 may be arranged in the X-axis direction. The movable drive electrode 116 can oscillate along the X-axis in accordance with oscillation of the oscillating body 112.

The stationary drive electrodes 130 and 132 are fixed onto the substrate 11, and are provided on a +Y direction side of the oscillating body 112 and on a −Y direction side of the oscillating body 112.

The stationary drive electrodes 130 and 132 are provided to face the movable drive electrode 116 with the movable drive electrode 116 interposed therebetween. More specifically, with regard to the stationary drive electrodes 130 and 132 between which the movable drive electrode 116 is interposed, in the first structure body 106, the stationary drive electrode 130 is provided on a −X direction side of the movable drive electrode 116, and the stationary drive electrode 132 is provided on a +X direction side of the movable drive electrode 116. In the second structure body 108, the stationary drive electrode 130 is provided on the +X direction side of the movable drive electrode 116, and the stationary drive electrode 132 is provided on the −X direction side of the movable drive electrode 116.

In the example illustrated in FIG. 1, the stationary drive electrodes 130 and 132 have a comb tooth-like shape, and the movable drive electrode 116 has a shape capable of being inserted between teeth of the stationary drive electrodes 130 and 132. A plurality of the stationary drive electrodes 130 and 132 may be provided in correspondence with the number of the movable drive electrode 116, and may be arranged in the X-axis direction. The stationary drive electrodes 130 and 132, and the movable drive electrode 116 are electrodes to oscillate the oscillating body 112.

The movable monitor electrode 118 is connected to the oscillating body 112. The movable monitor electrode 118 extends from the oscillating body 112 in the +Y direction and the −Y direction. In the example illustrated in FIG. 1, the movable monitor electrode 118 is provided on the +Y direction side of the oscillating body 112 in the first structure body 106, and on the +Y direction side of the oscillating body 112 in the second structure body 108 one by one, and the plurality of movable drive electrodes 116 are arranged between the movable monitor electrodes 118. In addition, the movable monitor electrode 118 is provided on the −Y direction side of the oscillating body 112 in the first structure body 106 and the −Y direction side of the oscillating body 112 in the second structure body 108 one by one, and the plurality of movable drive electrodes 116 are arranged between the movable monitor electrodes 118. For example, a planar shape of each of the movable monitor electrodes 118 is the same as a planar shape of the movable drive electrode 116. The movable monitor electrode 118 oscillates, that is, reciprocates along the X-axis in accordance with oscillation of the oscillating body 112.

The stationary monitor electrodes 160 and 162 are fixed onto the substrate 11, and are provided on the +Y direction side of the oscillating body 112 and the −Y direction side of the oscillating body 112.

The stationary monitor electrodes 160 and 162 are provided to face the movable monitor electrode 118 with the movable monitor electrode 118 interposed therebetween. More specifically, with regard to the stationary monitor electrodes 160 and 162 between which the movable monitor electrode 118 is interposed, in the first structure body 106, the stationary monitor electrode 160 is provided on the −X direction side of the movable monitor electrode 118, and the stationary monitor electrode 162 is provided on the +X direction side of the movable monitor electrode 118. In the second structure body 108, the stationary monitor electrode 160 is provided on the +X direction side of the movable monitor electrode 118, and the stationary monitor electrode 162 is provided on the −X direction side of the movable monitor electrode 118.

The stationary monitor electrodes 160 and 162 have a comb tooth-like shape, and the movable monitor electrode 118 has a shape capable of being inserted between teeth of the stationary monitor electrodes 160 and 162.

The stationary monitor electrodes 160 and 162, and the movable monitor electrode 118 are electrodes which detect a signal that varies in correspondence with oscillation of the oscillating body 112, and are electrodes which detect an oscillation state of the oscillating body 112. More specifically, when the movable monitor electrode 118 displaces along the X-axis, electrostatic capacitance between the movable monitor electrode 118 and the stationary monitor electrode 160, and electrostatic capacitance between the movable monitor electrode 118 and the stationary monitor electrode 162 vary. According to this, a current of the stationary monitor electrodes 160 and 162 varies. As a result, it is possible to detect the oscillation state of the oscillating body 112 through detection of a variation of the current.

The displacement unit 122 is connected to the oscillating body 112 with the second spring unit 124 interposed therebetween. In the example illustrated in the drawing, a planar shape of the displacement unit 122 is a rectangle having long sides along the Y-axis. Furthermore, although not illustrated, the displacement unit 122 may be provided on an outer side of the oscillating body 112.

The second spring unit 124 is configured to displace the displacement unit 122 in the Y-axis direction. More specifically, the second spring unit 124 has a shape that extends in the Y-axis direction while reciprocating in the X-axis direction. Furthermore, the number of the second spring unit 124 is not particularly limited as long as the second spring unit 124 can allow the displacement unit 122 to displace along the Y-axis.

The movable detection electrode 126 is connected to the displacement unit 122. For example, a plurality of the movable detection electrodes 126 are provided. Each of the movable detection electrodes 126 extends from the displacement unit 122 along the +X direction and the −X direction.

The stationary detection electrodes 140 and 142 are fixed onto the substrate 11. More specifically, ends on one side of the stationary detection electrodes 140 and 142 are fixed onto the substrate 11, and ends on the other side extend to a displacement unit 122 side as free ends.

The stationary detection electrodes 140 and 142 are provided to face the movable detection electrode 126 with the movable detection electrode 126 interposed therebetween. More specifically, with regard to the stationary detection electrodes 140 and 142 between which the movable detection electrode 126 is interposed, in the first structure body 106, the stationary detection electrode 140 is provided on the −Y direction side of the movable detection electrode 126, and the stationary detection electrode 142 is provided on the +Y direction side of the movable detection electrode 126. In the second structure body 108, the stationary detection electrode 140 is provided on the +Y direction side of the movable detection electrode 126, and the stationary detection electrode 142 is provided on the −Y direction side of the movable detection electrode 126.

In the example illustrated in FIG. 1, a plurality of the stationary detection electrodes 140 and 142 are provided, and are alternately arranged along the Y-axis. The stationary detection electrodes 140 and 142, and the movable detection electrode 126 are electrodes which detect a signal (electrostatic capacitance) that varies in correspondence with oscillation of the oscillating body 112.

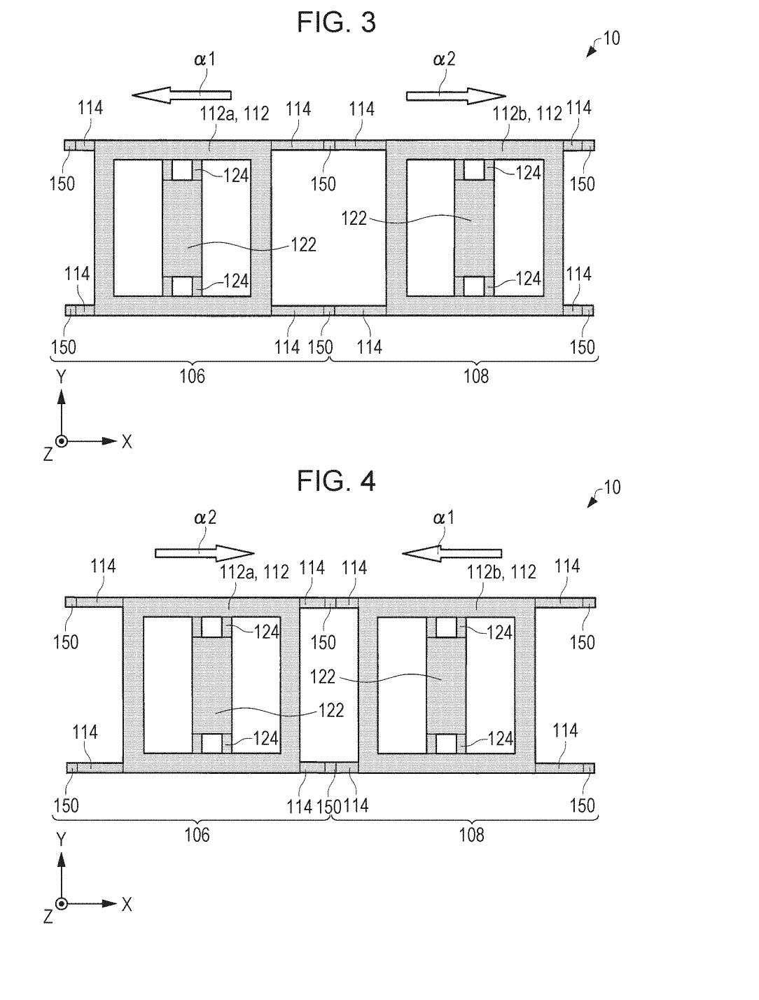

Next, description will be given of an operation of the angular velocity detection element 10. FIG. 3 to FIG. 6 are views illustrating the operation of the angular velocity detection element 10. Furthermore, in FIG. 3 to FIG. 6, the X-axis, the Y-axis, and the Z-axis are illustrated as three axes perpendicular to each other. In addition, in FIG. 3 to FIG. 6, the movable drive electrode 116, the movable monitor electrode 118, the movable detection electrode 126, the stationary drive electrodes 130 and 132, the stationary detection electrodes 140 and 142, and the stationary monitor electrodes 160 and 162 are not illustrated for convenience, and the angular velocity detection element 10 is illustrated in a simple manner.

When a voltage is applied between the movable drive electrode 116, and the stationary drive electrodes 130 and 132 by a power supply (not illustrated), an electrostatic force can be generated between the movable drive electrode 116, and the stationary drive electrodes 130 and 132 (refer to FIG. 1). According to this, as illustrated in FIG. 3 and FIG. 4, it is possible to extract and contract the first spring unit 114 along the X-axis, and it is possible to allow the oscillating body 112 to oscillate along the X-axis.

More specifically, a constant bias voltage Vr is applied to the movable drive electrode 116. In addition, a first AC voltage is applied to the stationary drive electrode 130 through a drive interconnection (not illustrated) on the basis of a predetermined voltage. In addition, a second AC voltage, of which a phase deviates from that of the first AC voltage by 180°, is applied to the stationary drive electrode 132 through a drive interconnection (not illustrated) on the basis of a predetermined voltage.

Here, with regard to the stationary drive electrodes 130 and 132 between which the movable drive electrode 116 is interposed, in the first structure body 106, the stationary drive electrode 130 is provided on the −X direction side of the movable drive electrode 116, and the stationary drive electrode 132 is provided on the +X direction side of the movable drive electrode 116 (refer to FIG. 1). In the second structure body 108, the stationary drive electrode 130 is provided on the +X direction side of the movable drive electrode 116, and the stationary drive electrode 132 is provided on the −X direction side of the movable drive electrode 116 (refer to FIG. 1). According to this, it is possible to allow an oscillating body 112a of the first structure body 106 and an oscillating body 112b of the second structure body 108 to oscillate along the X-axis in phases reversed from each other and at a predetermined frequency due to the first AC voltage and the second AC voltage. In an example illustrated in FIG. 3, the oscillating body 112a displaces in an α1 direction, and the oscillating body 112b displaces in an α2 direction that is opposite to the α1 direction. In an example illustrated in FIG. 4, the oscillating body 112a displaces in the α2 direction, and the oscillating body 112b displaces in the α1 direction.

Furthermore, the displacement unit 122 displaces along the X-axis in accordance with oscillation of the oscillating body 112. Similarly, the movable detection electrode 126 (refer to FIG. 1) displaces along the X-axis in accordance with oscillation of the oscillating body 112.

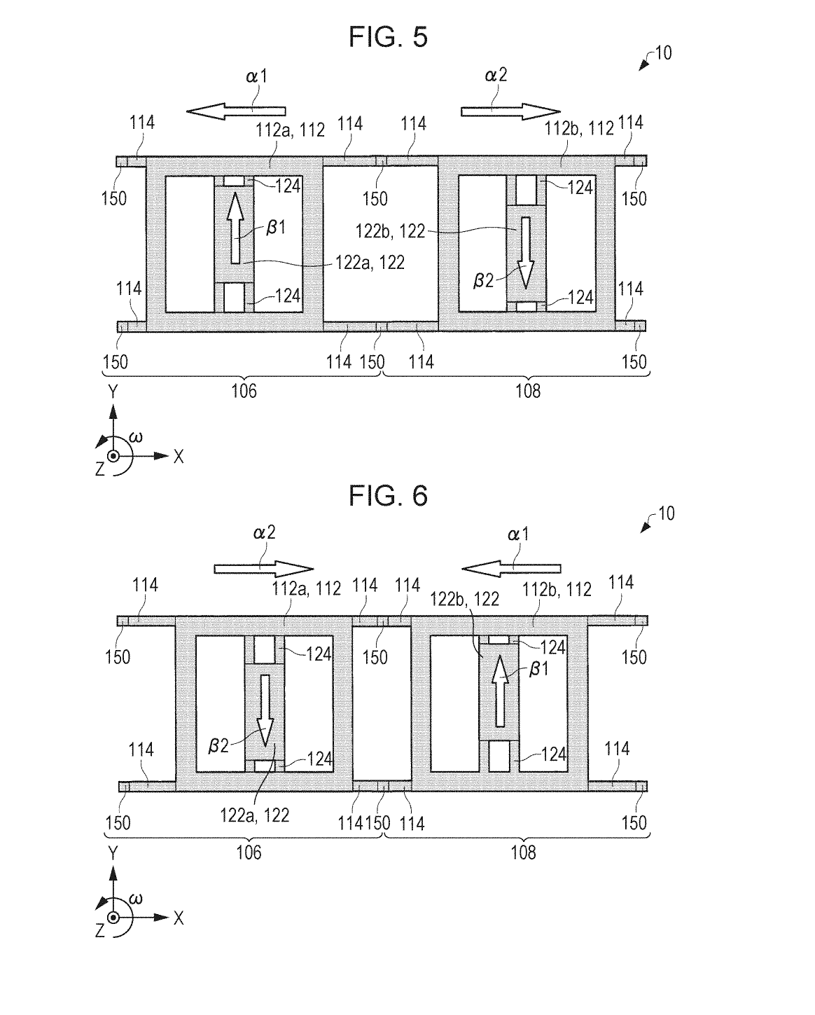

As illustrated in FIG. 5 and FIG. 6, when an angular velocity ω of Z-axis rotation is applied to the angular velocity detection element 10 in a state in which the oscillating bodies 112a and 112b oscillate along the X-axis, a Coriolis force acts thereon, and thus the displacement unit 122 displaces along the Y-axis. That is, a displacement unit 122a connected to the oscillating body 112a and a displacement unit 122b connected to the oscillating body 112b displace along the Y-axis in directions opposite to each other. In an example illustrated in FIG. 5, the displacement unit 122a displaces in a β1 direction, and the displacement unit 122b displaces in a β2 direction opposite to the β1 direction. In an example illustrated in FIG. 6, the displacement unit 122a displaces in the β2 direction, and the second displacement unit 122b displaces in the β1 direction.

When the displacement units 122a and 122b displace along the Y-axis, a distance between the movable detection electrode 126 and the stationary detection electrode 140 varies (refer to FIG. 1). Similarly, a distance between the movable detection electrode 126 and the stationary detection electrode 142 varies (refer to FIG. 1). According to this, electrostatic capacitance between the movable detection electrode 126 and the stationary detection electrode 140 varies. Similarly, electrostatic capacitance between the movable detection electrode 126 and the stationary detection electrode 142 varies.

In the angular velocity detection element 10, it is possible to detect a variation amount of electrostatic capacitance between the movable detection electrode 126 and the stationary detection electrode 140 by applying a voltage between the movable detection electrode 126 and the stationary detection electrode 140 (refer to FIG. 1). In addition, it is possible to detect a variation amount of electrostatic capacitance between the movable detection electrode 126 and the stationary detection electrode 142 by applying a voltage between the movable detection electrode 126 and the stationary detection electrode 142 (refer to FIG. 1). In this manner, the angular velocity detection element 10 can obtain the angular velocity ω of the Z-axis rotation in accordance with the variation amount of the electrostatic capacitance between the movable detection electrode 126, and each of the stationary detection electrodes 140 and 142.

In addition, in the angular velocity detection element 10, when the oscillating bodies 112a and 112b oscillate along the X-axis, a distance between the movable monitor electrode 118 and the stationary monitor electrode 160 varies (refer to FIG. 1). Similarly, a distance between the movable monitor electrode 118 and the stationary monitor electrode 162 varies (refer to FIG. 1). According to this, electrostatic capacitance between the movable monitor electrode 118 and the stationary monitor electrode 160 varies. Similarly, electrostatic capacitance between the movable monitor electrode 118 and the stationary monitor electrode 162 varies. In accordance with the variation, a current that flows to the stationary monitor electrodes 160 and 162 varies. It is possible to detect (monitor) an oscillation state of the oscillating bodies 112a and 112b in accordance with the variation of the current.

In the angular velocity detection element 10, as illustrated in FIG. 1, the stationary detection electrodes 140 and 142 are provided in regions on both sides of reciprocating motion ends of the movable detection electrode 126.

Configuration and Operation of Angular Velocity Detection Device

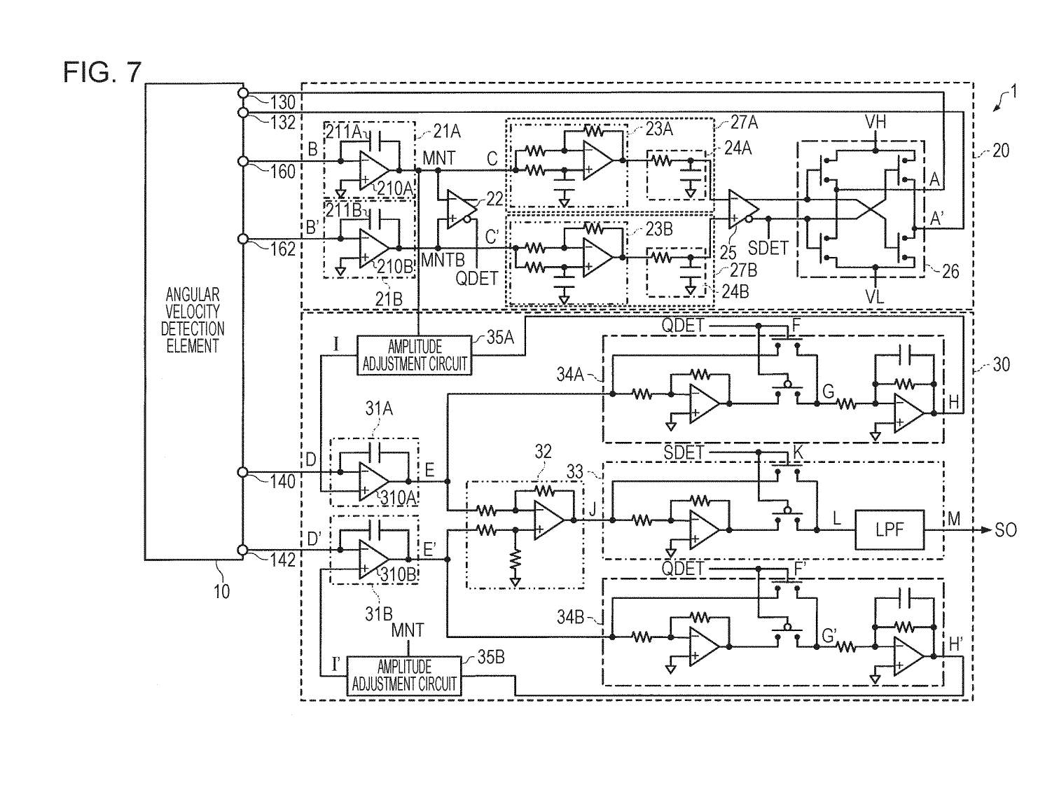

FIG. 7 is a view illustrating a configuration of an angular velocity detection device 1 according to the first embodiment. As illustrated in FIG. 7, the angular velocity detection device 1 according to the first embodiment includes the angular velocity detection element 10 illustrated in FIG. 1, a drive circuit 20, and an angular velocity detection circuit 30.

The drive circuit 20 generates a drive signal on the basis of a signal transmitted from the stationary monitor electrodes 160 and 162 of the angular velocity detection element 10, and outputs the drive signal to the stationary drive electrodes 130 and 132. The drive circuit outputs the drive signal to drive the angular velocity detection element 10, and receives a feedback signal from the angular velocity detection element 10. According to this, the angular velocity detection element 10 is excited.

The angular velocity detection circuit 30 receives a detection signal output from the angular velocity detection element 10 that is driven by the drive signal, and attenuates a quadrature signal (leakage signal) based on oscillation from the detection signal, and extracts a Coriolis signal based on the Coriolis force, thereby generating an angular velocity signal SO.

The drive circuit 20 in this embodiment includes two Q/V converters (charge amplifiers) 21A and 21B, a comparator 22, two phase shift circuits 23A and 23B, two band limiting filters 24A and 24B, a comparator 25, and a level conversion circuit 26.

When the oscillating body 112 of the angular velocity detection element 10 oscillates, currents, which are based on a capacitance variation and of which phases are inverted from each other, are output from the stationary monitor electrodes 160 and 162 as a feedback signal.

The Q/V converter 21A includes an operational amplifier 210A and a capacitor 211A, stores a current (charge), which is output from the stationary monitor electrode 160 of the angular velocity detection element 10 and is input to an inverting input terminal of the operational amplifier 210A, in the capacitor 211A, and converts the current into a voltage. Similarly, the Q/V converter 21B includes an operational amplifier 210B and a capacitor 211B, stores a current (charge), which is output from the stationary monitor electrode 162 of the angular velocity detection element 10 and is input to an inverting input terminal of the operational amplifier 210B, in the capacitor 211B, and converts the current into a voltage. Specifically, the Q/V converters 21A and 21B converts the current (charge), which is input, into a voltage based on an analog ground voltage AGND, and outputs AC voltage signals MNT and MNTB of the same frequency as an oscillation frequency of the oscillating body 112. The AC voltage signals MNT and MNTB are signals of which a phase advances by 90° with respect to the AC currents which are output from the stationary monitor electrodes 160 and 162.

The AC voltage signals MNT and MNTB, which are respectively output from the Q/V converters 21A and 21B, are input to the comparator 22. The comparator 22 compares a voltage of the AC voltage signal MNT and a voltage of the AC voltage signal MNTB, and outputs rectangular waveform signals, of which phases are inverted from each other, from a non-inverting output terminal and an inverting output terminal. In an example illustrated in FIG. 7, a rectangular waveform signal, which is output from the inverting output terminal of the comparator 22, is used as a quadrature reference signal QDET to be described later. When the voltage of the AC voltage signal MNT is higher than the voltage of the AC voltage signal MNTB, the quadrature reference signal QDET becomes a high level. When the voltage of the AC voltage signal MNT is lower than the voltage of the AC voltage signal MNTB, the quadrature reference signal QDET becomes a low level.

In addition, the AC voltage signals MNT and MNTB are respectively input to phase shift circuits 23A and 23B. The phase shift circuit 23A is a circuit that adjusts a phase of a drive signal, and outputs a signal in which a phase of the AC voltage signal MNT is shifted. Similarly, the phase shift circuit 23B is a circuit that adjusts a phase of a drive signal, and outputs a signal in which a phase of the AC voltage signal MNTB is shifted. In the example illustrated in FIG. 7, the phase shift circuits 23A and 23B are all-pass filters which allow pass signals of a full-frequency band to pass therethrough, but may be a circuit other than the filter.

The output signals of the phase shift circuits 23A and 23B are respectively input to band limiting filters 24A and 24B. The band limiting filter 24A is a circuit that limits a frequency band of the drive signal, allows a signal, which is included in the output signal of the phase shift circuit 23A and has the same frequency as that of an oscillation frequency, to pass therethrough, and attenuates a noise signal. Similarly, the band limiting filter 24B is a circuit that limits the frequency band of the drive signal, allows a signal, which is included in the output signal of the phase shift circuit 23B and has the same frequency as that of the oscillation frequency, to pass therethrough, and attenuates a noise signal. Particularly, in the example illustrated in FIG. 7, the band limiting filters 24A and 24B are set to a low-pass filter so as to attenuate a noise signal of a high frequency band, but may be set to a band-pass filter so as to attenuate a noise signal of a low frequency band.

As described above, since the AC voltage signal MNT is a signal of which a phase advances by 90° with respect to the AC current that is output from the stationary monitor electrode 160, the sum of a phase delay in the phase shift circuit 23A and a phase delay in the band limiting filter 24A becomes approximately 90° so as to satisfy oscillation conditions. Similarly, since the AC voltage signal MNTB is a signal of which a phase advances by 90° with respect to the AC current that is output from the stationary monitor electrode 162, the sum of a phase delay in the phase shift circuit 23B and a phase delay in the band limiting filter 24B becomes approximately 90° so as to satisfy oscillation conditions. For example, the phase delay in the phase shift circuits 23A and 23B may be 75°, and the phase delay in the band limiting filters 24A and 24B may be 15°.

As described above, the phase shift circuit 23A and the band limiting filter 24A adjust the phase of the drive signal, and constitute a phase adjustment unit 27A that limits a frequency band of the drive signal. Similarly, the phase shift circuit 23B and the band limiting filter 24B adjust the phase of the drive signal, and constitute a phase adjustment unit 27B that limits the frequency band of the drive signal. In the example illustrated in FIG. 7, the phase adjustment unit 27A and the phase adjustment unit 27B are realized by two circuits including the phase shift circuit 23A and the band limiting filter 24A, or two circuits including the phase shift circuit 23B and the band limiting filter 24B, but may be realized by one circuit (for example, a filter using an active element, an LC filter, and the like) having a function of a phase adjustment function and a band limiting function with respect to the AC voltage signal MNT or the AC voltage signal MNTB.

Output signals of the band limiting filters 24A and the band limiting filter 24B are input to the comparator 25. The comparator 25 compares the output voltage of the band limiting filter 24A (a voltage of the output signal of the phase adjustment unit 27A) and an output voltage of the band limiting filter 24B (a voltage of the output signal of the phase adjustment unit 27B), and outputs rectangular waveform signals, of which phases are inverted from each other, from a non-inverting output terminal and an inverting output terminal. In the example illustrated in FIG. 7, a rectangular waveform signal, which is output from the inverting output terminal of the comparator 25, is used as a Coriolis reference signal SDET to be described later. When the output voltage of the band limiting filter 24A is higher than the output voltage of the band limiting filter 24B, the Coriolis reference signal SDET becomes a high level. In addition, when the output voltage of the band limiting filter 24A is lower than the output voltage of the band limiting filter 24B, the Coriolis reference signal SDET becomes a low level.

The rectangular waveform signals, which are output from the comparator 25 and of which phases are inverted from each other, are input to the level conversion circuit 26. The level conversion circuit 26 converts a voltage level of the output signal of the comparator 25. Specifically, the level conversion circuit 26 converts rectangular waveform signals, which are output from the comparator 25 of which phases are inverted from each other, into rectangular waveform signals in which a high level is set to a voltage VH and a low level is set to a voltage VL. The rectangular waveform signals, which are output from the level conversion circuit 26 and of which phases are inverted from each other, are respectively input to the stationary drive electrodes 130 and 132 of the angular velocity detection element 10 as a drive signal. The angular velocity detection element 10 is driven by the drive signal that is input to the stationary drive electrodes 130 and 132.

A circuit, which is constituted by the comparator 25 and the level conversion circuit 26, functions as a drive signal generation unit that generates a drive signal for driving the angular velocity detection element 10 on the basis of the output signals from the phase adjustment units 27A and 27B.

Here, in this embodiment, in consideration of a situation in which a current output from the angular velocity detection element 10 that is an electrostatic capacitive MEMS element is very small, and thus the current is received by the Q/V converter 21A and 21B instead of an I/V converter. The current (charge), which is output from the angular velocity detection element 10, is accumulated in the capacitors 211A and 211B, and is sufficiently amplified by the operational amplifiers 210A and 210B. Accordingly, in output signals of the Q/V converters 21A and 21B, a decrease in S/N is suppressed, and thus it is possible to maintain high S/N.

In addition, in this embodiment, with regard to an oscillation frequency f0 of the oscillating body 112, an amplitude gain of the phase shift circuits 23A and 23B is 1, and an amplitude gain of the band limiting filters 24A and 24B is also 1. Accordingly, the output signals of the Q/V converters 21A and 21B are respectively output from the band limiting filters 24A and 24B in a state in which an amplitude is hardly attenuated. In addition, the band limiting filters 24A and 24B are respectively provided on a rear stage side of the phase shift circuits 23A and 23B. Accordingly, it is possible to attenuate a high-frequency noise that occurs in the phase shift circuits 23A and 23B by the band limiting filters 24A and 24B. Accordingly, even in the output signals of the band limiting filters 24A and 24B, the same high S/N as in the output signals of the Q/V converters 21A and 21B is maintained. As a result, a jitter of the drive signal is reduced, and a jitter of the Coriolis reference signal SDET or the quadrature reference signal QDET, which varies in conjunction with the drive signal, is also reduced.

The angular velocity detection circuit 30 in this embodiment includes two Q/V converters (charge amplifiers) 31A and 31B, a differential amplifier 32, a Coriolis synchronous detection circuit 33, two quadrature synchronous detection circuits 34A and 34B, and two amplitude adjustment circuits 35A and 35B.

Detection signals (AC current), which are output from the stationary detection electrodes 140 and 142 of the angular velocity detection element 10, include a Coriolis signal that is an angular velocity component based on a Coriolis force that acts on the angular velocity detection element 10, and a quadrature signal (leakage signal) that is a self-oscillation component based on an exciting oscillation of the angular velocity detection element 10. Phases of the quadrature signal (leakage signal) and the Coriolis signal (angular velocity component), which are included in the detection signal output from the stationary detection electrode 140, deviate from each other by 90°. Similarly, phases of the quadrature signal (leakage signal) and the Coriolis signal (angular velocity component), which are included in the detection signal output from the stationary detection electrode 142, deviate from each other by 90°. In addition, with regard to the Coriolis signals (angular velocity component) and the quadrature signals (leakage signals) which are included in the detection signals output from the stationary detection electrodes 140 and 142, phases of the Coriolis signals are inverted from each other, and phases of the quadrature signals are inverted from each other.

The Q/V converter 31A (an example of a first conversion unit) includes an operational amplifier 310A (an example of a first operational amplifier), and converts a current (an example of a first detection signal), which is output from the stationary detection electrode 140 (an example of a first detection electrode) of the angular velocity detection element 10 and is input to an inverting input terminal (an example of a first input terminal) of the operational amplifier 310A, into a voltage. Similarly, the Q/V converter 31B (an example of a second conversion unit) includes an operational amplifier 310B (an example of a second operational amplifier), and converts a current (an example of a second detection signal), which is output from the stationary detection electrode 142 (an example of a second detection electrode) of the angular velocity detection element 10 and is input to an inverting input terminal (an example of a first input terminal) of the operational amplifier 310B, into a voltage.

Specifically, when the oscillating body 112 of the angular velocity detection element 10 oscillates, currents, which are based on a capacitance variation, are output from the stationary detection electrodes 140 and 142, and are input to the inverting input terminals of the operational amplifiers 310A and 310B of the Q/V converters 31A and 31B. The Q/V converter 31A converts an AC current, which is output from the stationary detection electrode 140, into a voltage based on an output signal of the amplitude adjustment circuit 35A, and outputs the resultant signal. Similarly, Q/V converter 31B converts a current, which is output from the stationary detection electrode 142, into a voltage based on an output signal of the amplitude adjustment circuit 35B, and outputs the resultant signal. The signals, which are output from the Q/V converters 31A and 31B, are signals of which a phase advances by 90° with respect to the AC currents output from the stationary detection electrodes 140 and 142.

The AC voltage signals, which are respectively output from the Q/V converters 31A and 31B, are input to the differential amplifier 32. The differential amplifier 32 (an example of a differential amplifier unit) differentially amplifies the output signal (AC voltage signal) of the Q/V converter 31A and the output signal (AC voltage signal) of the Q/V converter 31B, and outputs the resultant signals.

The signals, which are output from the differential amplifier 32, are input to the Coriolis synchronous detection circuit 33. The Coriolis synchronous detection circuit 33 synchronously detects the signals output from the differential amplifier 32 on the basis of the Coriolis reference signal SDET. More specifically, when the Coriolis reference signal SDET is in a high level, the Coriolis synchronous detection circuit 33 selects a signal output from the differential amplifier 32, and when the Coriolis reference signal SDET is in a low level, the Coriolis synchronous detection circuit 33 selects a signal obtained by inverting polarity of a signal output from the differential amplifier 32 to perform full-wave rectification, and outputs a signal, which is obtained by the full-wave rectification, after performing low-pass filter processing. The signal, which is output from the Coriolis synchronous detection circuit 33, is a signal obtained by extracting the Coriolis signal (angular velocity component) from the detection signals output from the stationary detection electrodes 140 and 142 of the angular velocity detection element 10, and becomes a voltage corresponding to the magnitude of the Coriolis signal (angular velocity component). The signals, which are output from the Coriolis synchronous detection circuit 33, are output to the outside of the angular velocity detection device 1 as an angular velocity signal SO. As described above, the jitter of the Coriolis reference signal SDET is reduced, and thus accuracy of the synchronous detection by the Coriolis synchronous detection circuit 33 is also improved. As a result, detection accuracy of the angular velocity is improved.

A circuit, which is constituted by the differential amplifier 32 and the Coriolis synchronous detection circuit 33, functions as an angular velocity signal generation unit that generates the angular velocity signal SO on the basis of the output signals of the Q/V converters 31A and 31B.

The AC voltage signals, which are respectively output from the Q/V converters 31A and 31B, are also respectively input to the quadrature synchronous detection circuits 34A and 34B. The quadrature synchronous detection circuit 34A (an example of a first synchronous detection circuit) detects a level of a quadrature signal (leakage signal) included in the AC current that is output from the stationary detection electrode 140 of the angular velocity detection element 10 on the basis of the output signal (AC voltage signal) of the Q/V converter 31A. In addition, the quadrature synchronous detection circuit 34B (an example of a second synchronous detection circuit) detects a level of a quadrature signal (leakage signal) included in the AC current that is output from the stationary detection electrode 142 of the angular velocity detection element 10 on the basis of the output signal (AC voltage signal) of the Q/V converter 31B.

Specifically, the quadrature synchronous detection circuit 34A synchronously detects the output signal (AC voltage signal) of the Q/V converter 31A on the basis of the quadrature reference signal QDET to detect a level of the quadrature signal (leakage signal). That is, when the quadrature reference signal QDET is in a high level, the quadrature synchronous detection circuit 34A selects an AC voltage signal output from the Q/V converter 31A, and when quadrature reference signal QDET is in a low level, the quadrature synchronous detection circuit 34A selects a signal obtained by inverting polarity of an AC voltage signal output from the Q/V converter 31A to perform full-wave rectification, and outputs a signal, which is obtained by the full-wave rectification, after performing integration processing. The signal, which is output from the quadrature synchronous detection circuit 34A, is a signal obtained by extracting the quadrature signal (leakage signal) from the detection signal output from the stationary detection electrode 140 of the angular velocity detection element 10, and becomes a voltage corresponding to the magnitude of the quadrature signal (leakage signal).

Similarly, the quadrature synchronous detection circuit 34B synchronously detects the output signal (AC voltage signal) of the Q/V converter 31B on the basis of the quadrature reference signal QDET to detect the level of the quadrature signal (leakage signal). That is, when the quadrature reference signal QDET is in a high level, the quadrature synchronous detection circuit 34B selects an AC voltage signal output from the Q/V converter 31B, and when quadrature reference signal QDET is in a low level, the quadrature synchronous detection circuit 34B selects a signal obtained by inverting polarity of an AC voltage signal output from the Q/V converter 31B to perform full-wave rectification, and outputs a signal, which is obtained by the full-wave rectification, after performing integration processing. The signal, which is output from the quadrature synchronous detection circuit 34B, is a signal obtained by extracting the quadrature signal (leakage signal) from the detection signal output from the stationary detection electrode 142 of the angular velocity detection element 10, and becomes a voltage corresponding to the magnitude of the quadrature signal (leakage signal). Phases of the signals output from the quadrature synchronous detection circuits 34A and 34B are inverted from each other.

The signals, which are output from the quadrature synchronous detection circuits 34A and 34B, are respectively input to the amplitude adjustment circuits 35A and 35B. The amplitude adjustment circuit 35A outputs a signal obtained by adjusting an amplitude of the AC voltage signal MNT so as to cancel the quadrature signal (leakage signal) that is input to the Q/V converter 31A in correspondence with the output signal of the quadrature synchronous detection circuit 34A. Similarly, the amplitude adjustment circuit 35B outputs a signal obtained by adjusting an amplitude of the AC voltage signal MNT so as to cancel the quadrature signal (leakage signal) that is input to the Q/V converter 31B in correspondence with the output signal of the quadrature synchronous detection circuit 34B. The signals, which are respectively output from the amplitude adjustment circuits 35A and 35B, are AC voltage signals which have the same frequency as the oscillation frequency (frequency of the quadrature signal (leakage signal)) and have an amplitude that is determined in accordance with the magnitude of the quadrature signal (leakage signal). In addition, the AC voltage signals, which are output from the amplitude adjustment circuits 35A and 35B, are directly input to non-inverting input terminals (an example of a second input terminal) of the operational amplifiers 310A and 310B of the Q/V converters 31A and 31B.

The AC voltage signal, which is input to the non-inverting input terminal of the operational amplifier 310A, acts to remove the quadrature signal (leakage signal) included in the current that is output from the stationary detection electrode 140 of the angular velocity detection element 10 and is input to the inverting input terminal of the operational amplifier 310A. Accordingly, in the output signal of the Q/V converter 31A, the quadrature signal (leakage signal) is greatly attenuated. Similarly, the AC voltage signal, which is input to the non-inverting input terminal of the operational amplifier 310B, acts to remove the quadrature signal (leakage signal) included in the current that is output from the stationary detection electrode 142 of the angular velocity detection element 10 and is input to the inverting input terminal of the operational amplifier 310B. Accordingly, in the output signal of the Q/V converter 31B, the quadrature signal (leakage signal) is greatly attenuated. As a result, it is possible to reduce an offset of the angular velocity signal SO that occurs due to the quadrature signal (leakage signal). In addition, the level of the quadrature signal (leakage signal) included in the output signal of the Q/V converters 31A and 31B is small, and thus it is possible to enlarge a gain of the Q/V converters 31A and 31B in comparison to the related art in a range in which the output signals of the Q/V converters 31A and 31B is not satisfied. In addition, as described above, in this embodiment, the jitter of the quadrature reference signal QDET is reduced, and thus accuracy of the synchronous detection by the quadrature synchronous detection circuits 34A and 34B is improved. As a result, it is possible to further improve S/N of the angular velocity signal SO in comparison to the related art. Hereinafter, a signal, which is input to non-inverting input terminal of the operational amplifiers 310A and 310B, is referred to as “quadrature correction signal”.

As described above, a circuit, which is constituted by the quadrature synchronous detection circuit 34A and the amplitude adjustment circuit 35A, functions as a first correction signal generation unit that generates a quadrature correction signal (an example of a first correction signal) for reducing the offset of the angular velocity signal SO, which occurs due to the quadrature signal (leakage signal) included in the AC current that is output from the stationary detection electrode 140 of the angular velocity detection element 10, on the basis of the AC voltage signal MNT that is a signal based on drive oscillation of the angular velocity detection element 10. In addition, the amplitude adjustment circuit 35A functions as a first amplitude adjustment unit that adjusts an amplitude of the quadrature correction signal on the basis of the level of the quadrature signal (leakage signal) which is detected by the quadrature synchronous detection circuit 34A.

Similarly, a circuit, which is constituted by the quadrature synchronous detection circuit 34B and the amplitude adjustment circuit 35B, functions as a second correction signal generation unit that generates a quadrature correction signal (an example of a second correction signal) for reducing the offset of the angular velocity signal SO, which occurs due to the quadrature signal (leakage signal) included in the AC current that is output from the stationary detection electrode 142 of the angular velocity detection element 10, on the basis of the AC voltage signal MNT that is a signal based on drive oscillation of the angular velocity detection element 10. In addition, the amplitude adjustment circuit 35B functions as a second amplitude adjustment unit that adjusts an amplitude of the quadrature correction signal on the basis of the level of the quadrature signal (leakage signal) which is detected by the quadrature synchronous detection circuit 34B.

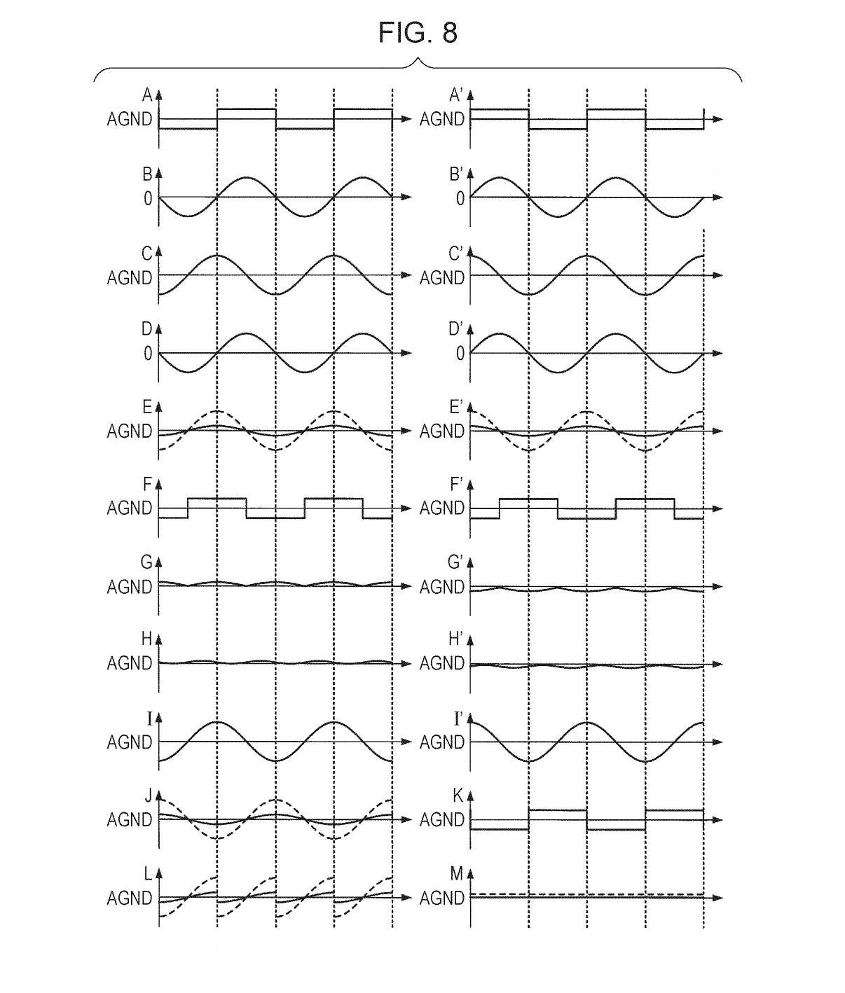

Next, description will be given of the principle of removing the quadrature signal (leakage signal) by the angular velocity detection device 1 illustrated in FIG. 7 with reference to a waveform diagram in FIG. 8. FIG. 8 is a view illustrating an example of a signal waveform at a point A to a point M in FIG. 7. In FIG. 8, the horizontal axis represents time, and the vertical axis represents a voltage or a current. FIG. 8 illustrates an example in a case where the Coriolis force is not applied to the angular velocity detection element 10, but the same description can be made even in a case where the Coriolis force is applied.

In a state in which the oscillating body 112 of the angular velocity detection element 10 oscillates, drive signal (signals at the point A and the point A′), which are output from the level conversion circuit 26, are rectangular waves of which phases are inverted from each other. In addition, phases of the AC currents (signals at the point B and the point B′), which are input to the Q/V converters 21A and 21B are inverted from each other, and phases of the AC voltage signals MNT and MNTB (signals at the point C and the point C′), which are output from the Q/V converters 21A and 21B, are inverted from each other. The phases of the AC voltage signals MNT and MNTB (signals at the point C and the point C′) advance by 90° with respect to the AC currents (signals at the point B and the point B′) which are respectively input to the Q/V converters 21A and 21B.

Since the Coriolis force is not applied to the angular velocity detection element 10, and thus the detection signals (signals at the point D and the point D′), which are input to the Q/V converters 31A and 31B, do not include the Coriolis signal and include only the quadrature signal (leakage signal). Phases of the quadrature signals (leakage signals) (signals at the point D and the point D′), which are input to the Q/V converters 31A and 31B, are inverted from each other, and the quadrature signals have the same phases as those of the AC currents (signals at the point B and the point B′) which are respectively input to the Q/V converters 21A and 21B.

The quadrature correction signal (signal at the point I), which is input to the Q/V converter 31A, has a waveform in which an amplitude of the AC voltage signal MNT (signal at the point C) is adjusted by the amplitude adjustment circuit 35A in correspondence with a waveform of the output signal (signal at the point H) of the quadrature synchronous detection circuit 34A. Similarly, the quadrature correction signal (signal at the point I′), which is input to the Q/V converter 31B, has a waveform in which an amplitude of the AC voltage signal MNT (signal at the point C) is adjusted by the amplitude adjustment circuit 35B in correspondence with a waveform of the output signal (signal at the point H′) of the quadrature synchronous detection circuit 34B.

The phase of the quadrature correction signal (signal at the point I), which is input to the Q/V converter 31A, advances by 90° with respect to the detection signal (quadrature signal (leakage signal)) (signal at the point D) that is input to the Q/V converter 31A, and the quadrature correction signal is added to a signal of which a phase advances by 90° with respect to an AC voltage signal (detection signal (AC current)) obtained by converting the detection signal (AC current) into a voltage in the Q/V converter 31A. Accordingly, the output signal (signal at the point E) of the Q/V converter 31A has a waveform (solid-line waveform) in which an amplitude of the quadrature signal (leakage signal) is attenuated.

Similarly, the phase of the quadrature correction signal (signal at the point I′), which is input to the Q/V converter 31B, advances by 90° with respect to the detection signal (quadrature signal (leakage signal)) (signal at the point D′) that is input to the Q/V converter 31B, and the quadrature correction signal is added to a signal of which a phase advances by 90° with respect to an AC voltage signal (detection signal (AC current)) obtained by converting the detection signal (AC current) into a voltage in the Q/V converter 31B. Accordingly, the output signal (signal at the point E′) of the Q/V converter 31B has a waveform quadrature signal (leakage signal) is attenuated.

In addition, in the quadrature synchronous detection circuit 34A, a signal (signal at the point G), which is obtained through the full-wave rectification of the output signal (signal (solid-line waveform) at the point E) of the Q/V converter 31A in accordance with the quadrature reference signal QDET (signal at the point F), has a positive-polarity waveform in which an amplitude is small. Accordingly, an integration signal (signal at the point H) of the full-wave rectified signal (signal at the point G) has a low level, and has a positive-polarity voltage waveform that is close to DC. In addition, for example, the amplitude of the quadrature correction signal (signal at the point I), which is input to the Q/V converter 31A, is adjusted by the amplitude adjustment circuit 35A so that the level of the output signal (signal at the point H) of the quadrature synchronous detection circuit 34A becomes the minimum. According to this, feedback is performed so that the amplitude of the output signal (signal at the point E) of the Q/V converter 31A is attenuated.

Similarly, in the quadrature synchronous detection circuit 34B, a signal (signal at the point G′), which is obtained through the full-wave rectification of the output signal (signal (solid-line waveform) at the point E′) of the Q/V converter 31B in accordance with the quadrature reference signal QDET (signal at the point F′), has a negative-polarity waveform in which an amplitude is small. Accordingly, an integration signal (signal at the point H′) of the full-wave rectified signal (signal at the point G′) has a low level, and has a negative-polarity voltage waveform that is close to DC. In addition, for example, the amplitude of the quadrature correction signal (signal at the point I′), which is input to the Q/V converter 31B, is adjusted by the amplitude adjustment circuit 35B so that the level of the output signal (signal at the point H′) of the quadrature synchronous detection circuit 34B becomes the minimum. According to this, feedback is performed so that the amplitude of the output signal (signal at the point E′) of the Q/V converter 31B is attenuated.

As a result, in the Coriolis synchronous detection circuit 33, a signal (signal at the point L) obtained through the full-wave rectification of the output signal (signal at the point J) of the differential amplifier 32 in accordance with the Coriolis reference signal SDET (signal at the point K) has a waveform (solid-line waveform) in which the positive polarity and the negative polarity repeat and an amplitude is small. Accordingly, the angular velocity signal SO (signal at the point M), which is a signal obtained by subjecting the full-wave rectified signal (signal at the point L) to the low-pass filtering processing, becomes a voltage (solid-line waveform) that is approximately the same as the analog ground voltage AGND even though symmetry between the positive-polarity waveform and the negative-polarity waveform in the full-wave rectified signal (signal at the point L) slightly deviates. That is, the offset of the angular velocity signal SO, which occurs due to the quadrature signal (leakage signal), is very small.

Furthermore, in a case where the quadrature correction signals (signals at the point I and the point I′) are not supplied to the non-inverting input terminals of the operational amplifiers 310A and 310B, and the analog ground voltage AGND is supplied thereto, the signals at the point E, the point E′, the point J, the point L, and the point M have waveforms similar to broken lines in FIG. 8, and the angular velocity signal SO (signal at the point M) becomes a voltage that deviates from the analog ground voltage AGND in correspondence with a deviation in symmetry between the positive-polarity waveform and the negative-polarity waveform in the full-wave rectified signal (signal at the point L). That is, the offset of the angular velocity signal SO, which occurs due to the quadrature signal (leakage signal), is great.

Operational Effect

As described above, according to the angular velocity detection device 1 (angular velocity detection circuit 30) according to the first embodiment, the quadrature correction signal is input to the inverting input terminals of the operational amplifiers 310A and 310B, and thus it is possible to reduce the offset of the angular velocity signal SO which occurs due to the quadrature signal (leakage signal) that is included in the detection signals output from the stationary detection electrodes 140 and 142 of the angular velocity detection element 10. In addition, the quadrature correction signal is directly input to the inverting input terminals of the operational amplifiers 310A and 310B. Accordingly, it is possible to further reduce a noise component included in the output signals of the Q/V converters 31A and 31B in comparison to the technology of the related art in which the quadrature correction signal is input through a capacitor. In addition, the quadrature correction signals of which an amplitude is adjusted by the amplitude adjustment circuits 35A and 35B, are input to the inverting input terminals of the operational amplifiers 310A and 310B, and thus the quadrature signal (leakage signal) is greatly attenuated in the output signals of the Q/V converters 31A and 31B. Accordingly, it is possible to enlarge a gain of the Q/V converters 31A and 31B in proportional to the attenuation. Accordingly, according to the angular velocity detection device 1 (angular velocity detection circuit 30) according to the first embodiment, a ratio of the angular velocity component (Coriolis signal) and the noise component, which are included in the output signals of the Q/V converters 31A and 31B, increases. As a result, it is possible to further improve S/N of the angular velocity signal SO that is generated on the basis of the output signals of the Q/V converters 31A and 31B in comparison to the related art.

In addition, according to the angular velocity detection device 1 (angular velocity detection circuit 30) according to the first embodiment, even when the amplitude of the quadrature signal (leakage signal), which is included in the detection signals output from the stationary detection electrodes 140 and 142 of the angular velocity detection element 10, varies, the amplitude of the quadrature correction signal is automatically adjusted in conformity to the variation. Accordingly, even when an environment varies, it is possible to constantly maintain S/N of the angular velocity signal SO.

In addition, according to the angular velocity detection device 1 (angular velocity detection circuit 30) according to the first embodiment, in a manufacturing process thereof, it is not necessary to inspect the amplitude of the quadrature signal (leakage signal) that is included in the detection signals output from the stationary detection electrodes 140 and 142 of the angular velocity detection element 10 so as to set information for adjusting the amplitude of the quadrature correction signal. As a result, it is also possible to reduce the manufacturing cost.

### 1-2. Second Embodiment

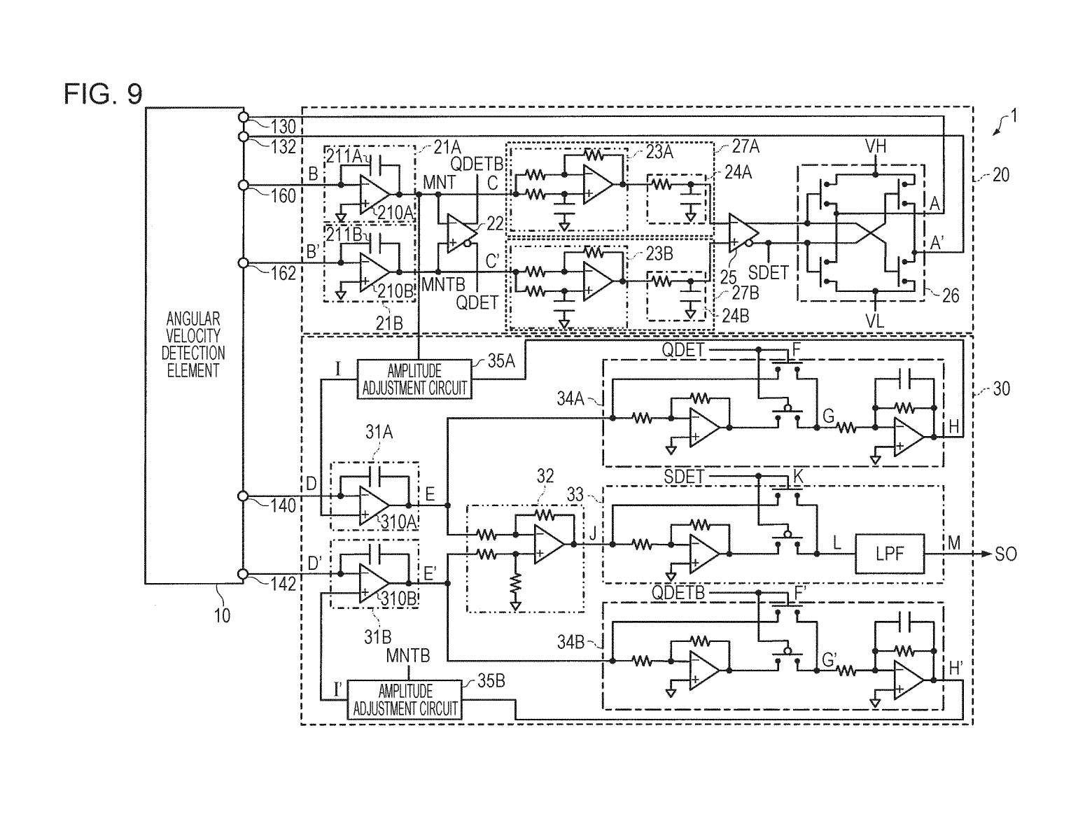

FIG. 9 is a view illustrating a configuration of an angular velocity detection device 1 according to a second embodiment. In FIG. 9, the same reference numeral is given to the same constituent element as in FIG. 7. Hereinafter, with regard to the angular velocity detection device 1 according to the second embodiment, description redundant with the first embodiment will be omitted, and description will be made with focus given to contents different from the first embodiment.

As illustrated in FIG. 9, in the angular velocity detection device 1 according to the second embodiment, a rectangular waveform signal, which is output from the non-inverting output terminal of the comparator 22, is input to a quadrature synchronous detection circuit 34B as a quadrature reference signal QDETB differently from the first embodiment. In addition, the quadrature synchronous detection circuit 34B synchronously detects the output signal (AC voltage signal) of the Q/V converter 31B on the basis of the quadrature reference signal QDETB to detect the level of the quadrature signal (leakage signal) that is included in the detection signal (AC current) output from the stationary detection electrode 142 of the angular velocity detection element 10.

Specifically, when the quadrature reference signal QDETB is in a high level (the quadrature reference signal QDET is in a low level), the quadrature synchronous detection circuit 34B selects an AC voltage signal output from the Q/V converter 31B, and when quadrature reference signal QDETB is in a low level (the quadrature reference signal QDET is in a high level), the quadrature synchronous detection circuit 34B selects a signal obtained by inverting polarity of an AC voltage signal output from the Q/V converter 31B to perform full-wave rectification, and outputs a signal, which is obtained by the full-wave rectification, after performing integration processing. A signal, which is output from the quadrature synchronous detection circuit 34B, is a signal obtained by extracting the quadrature signal (leakage signal) from the detection signal output from the stationary detection electrode 142 of the angular velocity detection element 10, and becomes a voltage corresponding to the magnitude of the quadrature signal (leakage signal). Phases of the signals output from the quadrature synchronous detection circuits 34A and 34B are the same as each other.

In addition, an AC voltage signal MNTB is input to the amplitude adjustment circuit 35B differently from the first embodiment. In addition, the amplitude adjustment circuit 35B outputs a quadrature correction signal obtained by adjusting an amplitude of the AC voltage signal MNTB so as to cancel the quadrature signal (leakage signal) that is input to the Q/V converter 31B in correspondence with the output signal of the quadrature synchronous detection circuit 34B.

The other configurations in the angular velocity detection device 1 according to the second embodiment are the same as those in the first embodiment (FIG. 7).

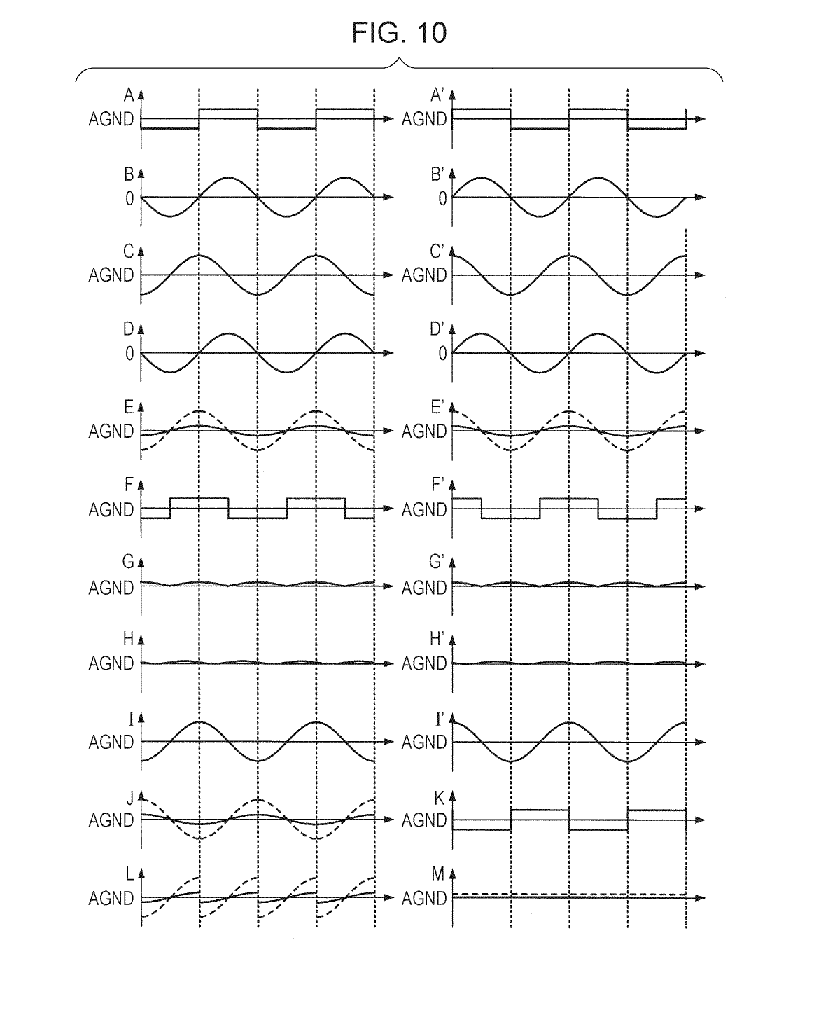

FIG. 10 is a view illustrating an example of a signal waveform at a point A to a point M in FIG. 9. In FIG. 10, the horizontal axis represents time, and the vertical axis represents a voltage or a current. FIG. 10 illustrates an example in a case where the Coriolis force is not applied to the angular velocity detection element 10 similar to FIG. 8. Furthermore, a signal waveform illustrated by a broken line is a signal waveform in a case where the analog ground voltage AGND is supplied to the non-inverting input terminals of the operational amplifiers 310A and 310B similar to FIG. 8.

FIG. 10 is the same as FIG. 8 except for signal waveforms at the point F′ and the point G′, and a signal waveform at the point H′. The polarity of signal waveforms at the point F′, the point G′, and the point H′ is inverted from the signal waveforms at the F′ point, the G′ point, and the H′ point in FIG. 8. In addition, the AC voltage signal MNTB (signal at the point C′), of which polarity is inverted from the AC voltage signal MNT (signal at the point C), is input to the amplitude adjustment circuit 35B, and thus a waveform of the quadrature correction signal (signal at the point I′) is the same as FIG. 8. As a result, the signal waveform of the angular velocity signal SO becomes the same as FIG. 8.

According to the above-described angular velocity detection device 1 (angular velocity detection circuit 30) according to the second embodiment, it is possible to exhibit the same effect as in the angular velocity detection device 1 (angular velocity detection circuit 30) according to the first embodiment.

### 1-3. Third Embodiment

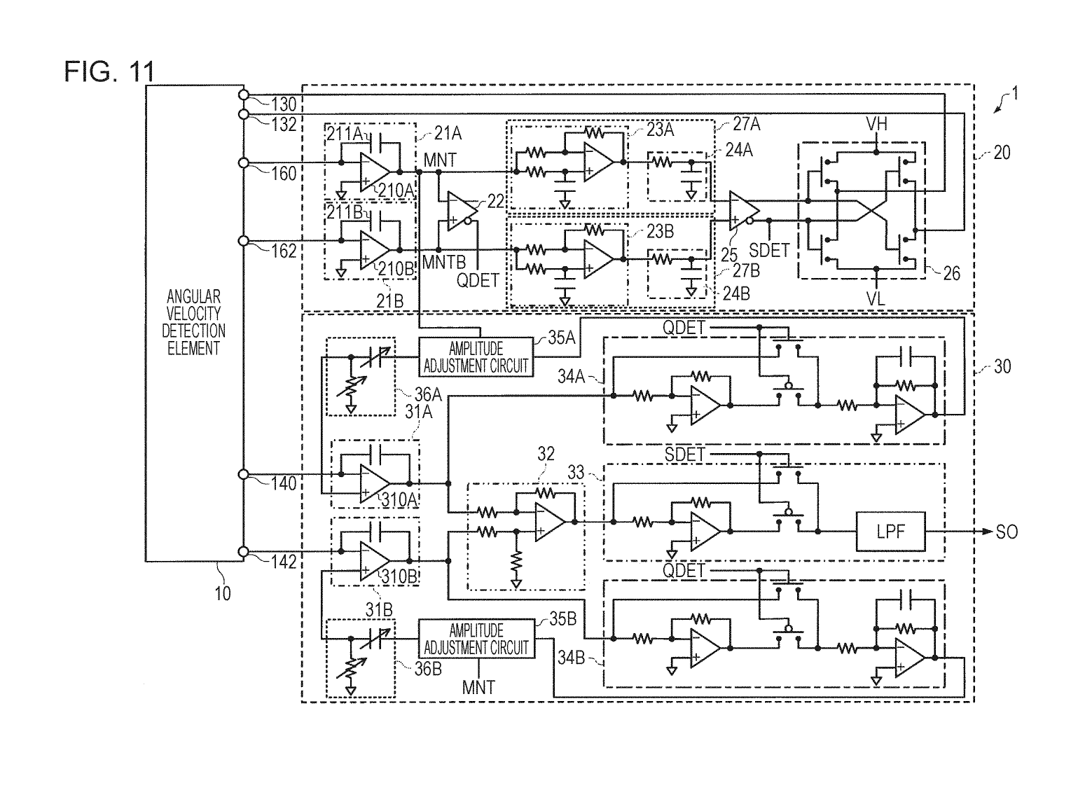

FIG. 11 is a view illustrating a configuration of an angular velocity detection device 1 according to a third embodiment. In FIG. 11, the same reference numeral is given to the same constituent element as in FIG. 7. Hereinafter, with regard to the angular velocity detection device 1 according to the third embodiment, description redundant with the first embodiment will be omitted, and description will be made with focus given to contents different from the first embodiment.

In the first embodiment, a deviation of a phase difference by 90° may occur between the signals which are respectively output from the amplitude adjustment circuits 35A and 35B and the detection signals (AC currents) which are respectively input to the inverting input terminals of the operation amplifiers 310A and 310B due to a phase delay in the amplitude adjustment circuits 35A and 35B. Accordingly, as illustrated in FIG. 11, in the angular velocity detection device 1 according to the third embodiment, two phase adjustment circuits 36A and 36B are further added with respect to the first embodiment (FIG. 7). The phase adjustment circuit 36A (an example of a first phase adjustment unit) is a circuit that adjusts a phase of a quadrature correction signal (an example of a first correction signal) that is input to the Q/V converter 31A (the non-inverting input terminal of the operational amplifier 310A). In addition, the phase adjustment circuit 36B (an example of a second phase adjustment unit) is a circuit that adjusts a phase of a quadrature correction signal (an example of a second correction signal) that is input to the Q/V converter 31B (the non-inverting input terminal of the operational amplifier 310B). Specifically, the phase adjustment circuit 36A adjusts the phase of the quadrature correction signal that is input to the non-inverting input terminal of the operational amplifier 310A so as to cancel the quadrature signal (leakage signal) that is input to the Q/V converter 31A on the basis of the level of the leakage signal which is detected by the quadrature synchronous detection circuit 34A. In addition, the phase adjustment circuit 36B adjusts the phase of the quadrature correction signal that is input to the non-inverting input terminal of the operational amplifier 310B so as to cancel the quadrature signal (leakage signal) that is input to the Q/V converter 31B on the basis of the level of the leakage signal which is detected by the quadrature synchronous detection circuit 34B. For example, the amount of phase advance in the phase adjustment circuits 36A and 36B may be changed in order for the quadrature signal (leakage signal) input to the Q/V converters 31A and 31B to be cancelled by changing at least one of a resistance value of a variable resistor and a capacitance value of a variable capacitor in each of the phase adjustment circuits 36A and 36B in correspondence with levels of respective output signals of the quadrature synchronous detection circuits 34A and 34B.

For example, the phase of the quadrature correction signal, which is input to the Q/V converter 31A, is adjusted by the phase adjustment circuit 36A so that the level of the output signal of the quadrature synchronous detection circuit 34A, becomes the minimum. According to this, feedback is performed so that the amplitude of the quadrature signal (leakage signal) included in the output signal of the Q/V converter 31A is attenuated. Similarly, for example, the phase of the quadrature correction signal, which is input to the Q/V converter 31B, is adjusted by the phase adjustment circuit 36B so that the level of the output signal of the quadrature synchronous detection circuit 34B, becomes the minimum. According to this, feedback is performed so that the amplitude of the quadrature signal (leakage signal) included in the output signal of the Q/V converter 31B is attenuated. As a result, it is possible to reduce an offset of the angular velocity signal SO which occur due to the quadrature signal (leakage signal).

As described above, a circuit, which is constituted by the quadrature synchronous detection circuit 34A, the amplitude adjustment circuit 35A, and the phase adjustment circuit 36A, functions as the first correction signal generation unit that generates the quadrature correction signal (an example of the first correction signal) for reducing the offset of the angular velocity signal SO, which occurs due to the quadrature signal (leakage signal) included in the AC current that is output from the stationary detection electrode 140 of the angular velocity detection element 10, on the basis of the AC voltage signal MNT that is a signal based on drive oscillation of the angular velocity detection element 10. Similarly, a circuit, which is constituted by the quadrature synchronous detection circuit 34B, the amplitude adjustment circuit 35B, and the phase adjustment circuit 36B, functions as the second correction signal generation unit that generates the quadrature correction signal (an example of the second correction signal) for reducing the offset of the angular velocity signal SO, which occurs due to the quadrature signal (leakage signal) included in the AC current that is output from the stationary detection electrode 142 of the angular velocity detection element 10, on the basis of the AC voltage signal MNT that is a signal based on drive oscillation of the angular velocity detection element 10.

The other configurations in the angular velocity detection device 1 according to the third embodiment are also the same as those in the first embodiment (FIG. 7).

As is the case with the angular velocity detection device 1 (angular velocity detection circuit 30) according to the first embodiment, according to the angular velocity detection device 1 (angular velocity detection circuit 30) according to the third embodiment, it is possible to reduce the offset of the angular velocity signal SO which occurs due to the quadrature signal (leakage signal) that is included in the detection signals output from the stationary detection electrodes 140 and 142 of the angular velocity detection element 10. In addition, it is possible to reduce the noise component that is included in the output signals of the Q/V converters 31A and 31B.

In addition, according to the angular velocity detection device 1 (angular velocity detection circuit 30) according to the third embodiment, the quadrature correction signals of which an amplitude and a phase are adjusted by the amplitude adjustment circuits 35A and 35B and the phase adjustment circuits 36A and 36B, are input to the non-inverting input terminals of the operational amplifiers 310A and 310B, and thus the quadrature signal (leakage signal) is further greatly attenuated in the output signals of the Q/V converters 31A and 31B. Accordingly, it is possible to enlarge a gain of the Q/V converters 31A and 31B in proportional to the attenuation. Accordingly, according to the angular velocity detection device 1 (angular velocity detection circuit 30) according to the third embodiment, a ratio of the angular velocity component (Coriolis signal) and the noise component, which are included in the output signals of the Q/V converters 31A and 31B, increases. As a result, it is possible to further improve S/N of the angular velocity signal SO that is generated on the basis of the output signals of the Q/V converters 31A and 31B.

In addition, according to the angular velocity detection device 1 (angular velocity detection circuit 30) according to the third embodiment, even when the amplitude or the phase of the quadrature signal (leakage signal), which is included in the detection signals output from the stationary detection electrodes 140 and 142 of the angular velocity detection element 10, varies, the amplitude or the phase of the quadrature correction signal is automatically adjusted in conformity to the variation. Accordingly, even when an environment varies, it is possible to constantly maintain S/N of the angular velocity signal SO.

In addition, according to the angular velocity detection device 1 (angular velocity detection circuit 30) according to the third embodiment, in a manufacturing process thereof, it is not necessary to inspect the amplitude or the phase of the quadrature signal (leakage signal) that is included in the detection signals output from the stationary detection electrodes 140 and 142 of the angular velocity detection element 10 so as to set information for adjusting the amplitude or the phase of the quadrature correction signal. As a result, it is also possible to reduce the manufacturing cost.

Furthermore, in an example illustrated in FIG. 11, the phase adjustment circuit 36A is provided between an output terminal of the amplitude adjustment circuit 35A and an input terminal of the Q/V converter 31A, but may be provided between an output terminal of the Q/V converter 21A and an input terminal of the amplitude adjustment circuit 35A. Similarly, the phase adjustment circuit 36B is provided between an output terminal of the amplitude adjustment circuit 35B and an input terminal of the Q/V converter 31B, but may be provided between an output terminal of the Q/V converter 21A and an input terminal of the amplitude adjustment circuit 35B. In addition, the phase adjustment circuits 36A and 36B may be added with respect to the angular velocity detection device 1 (FIG. 9) according to the second embodiment in the same manner.

### 1-4. Fourth Embodiment

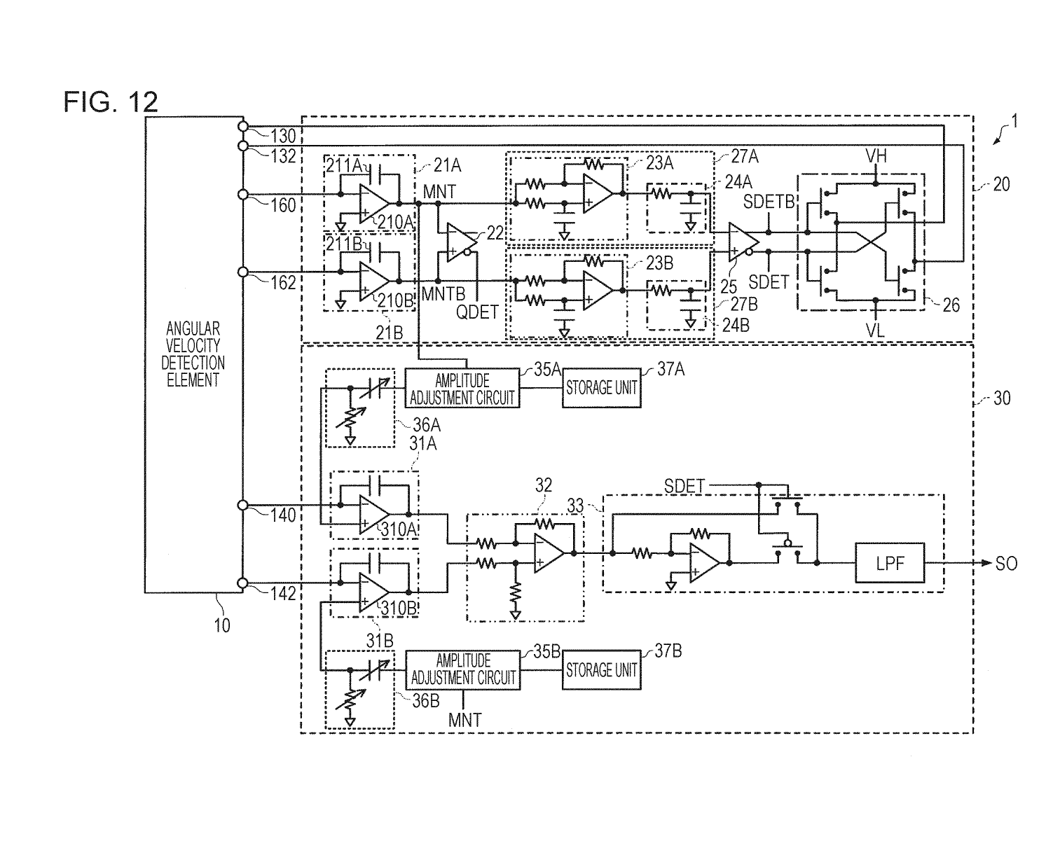

FIG. 12 is a view illustrating a configuration of an angular velocity detection device 1 according to a fourth embodiment. In FIG. 12, the same reference numeral is given to the same constituent element as in FIG. 11. Hereinafter, with regard to the angular velocity detection device 1 according to the fourth embodiment, description redundant with the first embodiment or the third embodiment will be omitted, and description will be made with focus given to contents different from the first embodiment and the third embodiment.

As illustrated in FIG. 12, in the angular velocity detection device 1 according to the fourth embodiment, with regard to the third embodiment, storage units 37A and 37B are provided instead of the quadrature synchronous detection circuits 34A and 34B. In addition, the amplitude adjustment circuit 35A adjusts an amplitude of the quadrature correction signal that is input to the Q/V converter 31A on the basis of information (amplitude adjustment information) that is stored in the storage unit 37A. In addition, the phase adjustment circuit 36A adjusts a phase of the quadrature correction signal that is input to the Q/V converter 31A on the basis of the information (phase adjustment information) that is stored in the storage unit 37A. Similarly, the amplitude adjustment circuit 35B adjusts an amplitude of the quadrature correction signal that is input to the Q/V converter 31B on the basis of information (amplitude adjustment information) that is stored in the storage unit 37B. In addition, the phase adjustment circuit 36B adjusts a phase of the quadrature correction signal that is input to the Q/V converter 31B on the basis of the information (phase adjustment information) that is stored in the storage unit 37B.

For example, the amplitude adjustment information stored in the storage unit 37A may be an integer value, and the amplitude adjustment circuit 35A may output a signal obtained by multiplying the amplitude of the AC voltage signal MNT by the constant. In addition, the phase adjustment information stored in the storage unit 37A may be an integer value, and the phase adjustment circuit 36A may output a quadrature correction signal of which a phase advances with respect to the output signal of the amplitude adjustment circuit 35A by changing at least one of a resistance value of a variable resistor and a capacitance value of a variable capacitor in correspondence with the integer value.

Similarly, the amplitude adjustment information stored in the storage unit 37B may be an integer value, and the amplitude adjustment circuit 35B may output a signal obtained by multiplying the amplitude of the AC voltage signal MNT by the constant. In addition, the phase adjustment information stored in the storage unit 37B may be an integer value, and the phase adjustment circuit 36B may output a quadrature correction signal of which a phase advances with respect to the output signal of the amplitude adjustment circuit 35B by changing at least one of a resistance value of a variable resistor and a capacitance value of a variable capacitor in correspondence with the integer value.

For example, in a process of inspecting the angular velocity detection device 1, the level of the quadrature signals (leakage signals), which are respectively input to the Q/V converters 31A and 31B, may be measured, and amplitude adjustment information corresponding to the resultant measurement value may be stored in non-volatile storage units 37A and 37B. In addition, in the process of inspecting the angular velocity detection device 1, a phase difference between the quadrature signals (leakage signals) which are respectively input to the Q/V converters 31A and 31B and the AC voltage signal MNT, may be measured, and phase adjustment information corresponding to the resultant measurement value may be stored in the non-volatile storage units 37A and 37B.

The other configurations of the angular velocity detection device 1 according to the fourth embodiment are the same as in the third embodiment (FIG. 11).

As is the case with the angular velocity detection device 1 (angular velocity detection circuit 30) according to the first embodiment, according to the angular velocity detection device 1 (angular velocity detection circuit 30) according to the fourth embodiment, it is possible to reduce the offset of the angular velocity signal SO which occurs due to the quadrature signal (leakage signal) that is included in the detection signals output from the stationary detection electrodes 140 and 142 of the angular velocity detection element 10. In addition, it is possible to reduce the noise component that is included in the output signals of the Q/V converters 31A and 31B. In addition, since the quadrature signal (leakage signal) is further greatly attenuated in the output signals of the Q/V converters 31A and 31B, it is possible to enlarge the gain of the Q/V converters 31A and 31B in proportional to the attenuation. As a result, it is possible to further improve S/N of the angular velocity signal SO that is generated on the basis of the output signals of the Q/V converters 31A and 31B.

In addition, according to the angular velocity detection device 1 (angular velocity detection circuit 30) according to the fourth embodiment, for example, in a manufacturing process thereof, the amplitude and the phase of the quadrature signal (leakage signal) that is included in the detection signals output from the stationary detection electrodes 140 and 142 of the angular velocity detection element 10 are inspected, and a plurality of pieces of information which correspond to the amplitude and the phase of the quadrature signal (leakage signal) are stored in the storage units 37A and 37B. According to this, it is possible to improve S/N of the angular velocity signal SO.

In addition, according to the angular velocity detection device 1 (angular velocity detection circuit 30) according to the fourth embodiment, when the amplitude or the phase of the quadrature signal (leakage signal), which is included in the detection signals output from the stationary detection electrodes 140 and 142 of the angular velocity detection element 10, varies due to an environmental variation, the amplitude or the phase of the AC voltage signal MNT also varies in the same manner. Accordingly, even when the level of the quadrature signal (leakage signal) is not detected, it is possible to constantly maintain S/N of the angular velocity signal SO to a certain extent. Accordingly, according to the angular velocity detection device 1 (angular velocity detection circuit 30) according to the fourth embodiment, the quadrature synchronous detection circuits 34A and 34B, which detect the level of the quadrature signal (leakage signal) that is included in the detection signals output from the stationary detection electrodes 140 and 142 of the angular velocity detection element 10, become unnecessary, and thus it is also possible to reduce a circuit area.

Furthermore, in the example illustrated in FIG. 12, the phase adjustment circuit 36A is provided between the output terminal of the amplitude adjustment circuit 35A and the input terminal of the Q/V converter 31A, but may be provided between the output terminal of the Q/V converter 21A and the input terminal of the amplitude adjustment circuit 35A. Similarly, the phase adjustment circuit 36B is provided between the output terminal of the amplitude adjustment circuit 35B and the input terminal of the Q/V converter 31B, but may be provided between an output terminal of the Q/V converter 21A and an input terminal of the amplitude adjustment circuit 35B. In addition, with regard to angular velocity detection device 1 (FIG. 7 or FIG. 9) according to the first embodiment or the second embodiment, the storage units 37A and 37B may be provided instead of the quadrature synchronous detection circuits 34A and 34B in the same manner.

### 2. MODIFICATION EXAMPLES

### 2-1. Modification Example 1

In the above-described embodiments, the quadrature correction signal is input to the non-inverting input terminals of the operational amplifiers 310A and 310B, but a modification may be made in such a manner that the quadrature correction signal is input to the inverting input terminals of the operational amplifiers 310A and 310B through a resistor.

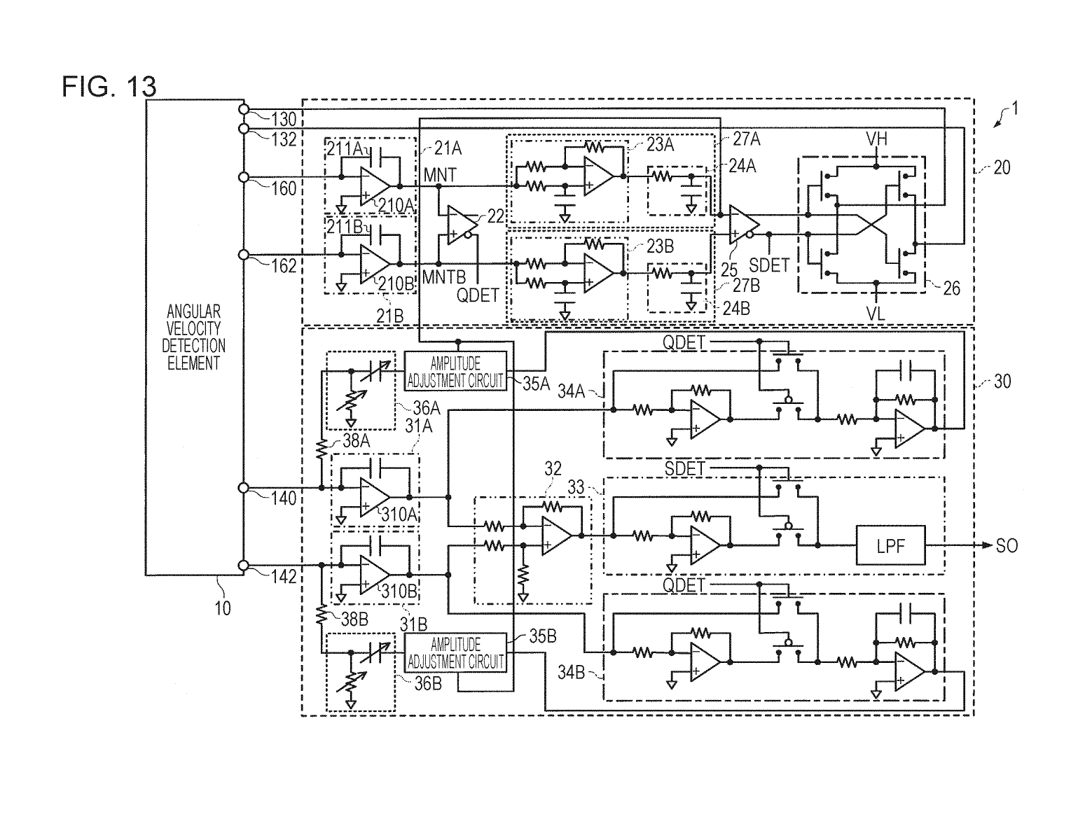

FIG. 13 illustrates a configuration of an angular velocity detection device 1 according to Modification Example 1 with respect to the angular velocity detection device 1 (FIG. 11) according to the third embodiment as an example. In the angular velocity detection device 1 according to Modification Example 1 in FIG. 13, the detection signal output from the stationary detection electrode 140 of the angular velocity detection element 10 is input to the inverting input terminal of the operational amplifier 310A, and the quadrature correction signal output from the phase adjustment circuit 36A is input to the inverting input terminal through a resistor 38A. In addition, the analog ground voltage AGND is supplied to the non-inverting input terminal of the operational amplifier 310A. Similarly, the detection signal output from the stationary detection electrode 142 of the angular velocity detection element 10 is input to the inverting input terminal of the operational amplifier 310B, and the quadrature correction signal output from the phase adjustment circuit 36B is input to the inverting input terminal through a resistor 38B. In addition, the analog ground voltage AGND is supplied to the non-inverting input terminal of the operational amplifier 310B.

Furthermore, the phases of the output signals (output signals of the operational amplifiers 310A and 310B) of the Q/V converters 31A and 31B advance by 90° with respect to input signals. Accordingly, it is necessary to retard the phase of the quadrature correction signal by 90° with respect to the above-described embodiments. According to this, an output signal (an example of a signal based on drive oscillation) of the phase adjustment unit 27A, which is obtained by retarding the phase of the AC voltage signal MNT by 90°, is input to the amplitude adjustment circuits 35A and 35B instead of the AC voltage signal MNT.

According to the angular velocity detection device according to Modification Example 1, it is possible to exhibit the same effect as in the above-described embodiments.

### 2-2. Modification Example 2

In the above-described embodiments, two detection signals, of which phases are inverted from each other, are output from the angular velocity detection element 10, and two-system feedback loops are provided to cancel the quadrature signal (leakage signal) included in the detection signals, but one of the two-system feedback loops may not be provided. Alternatively, a modification may be made in such a manner that only one detection signal is output from the angular velocity detection element 10, and only one-system feedback loop is provided to cancel the quadrature signal (leakage signal) included in the detection signal.

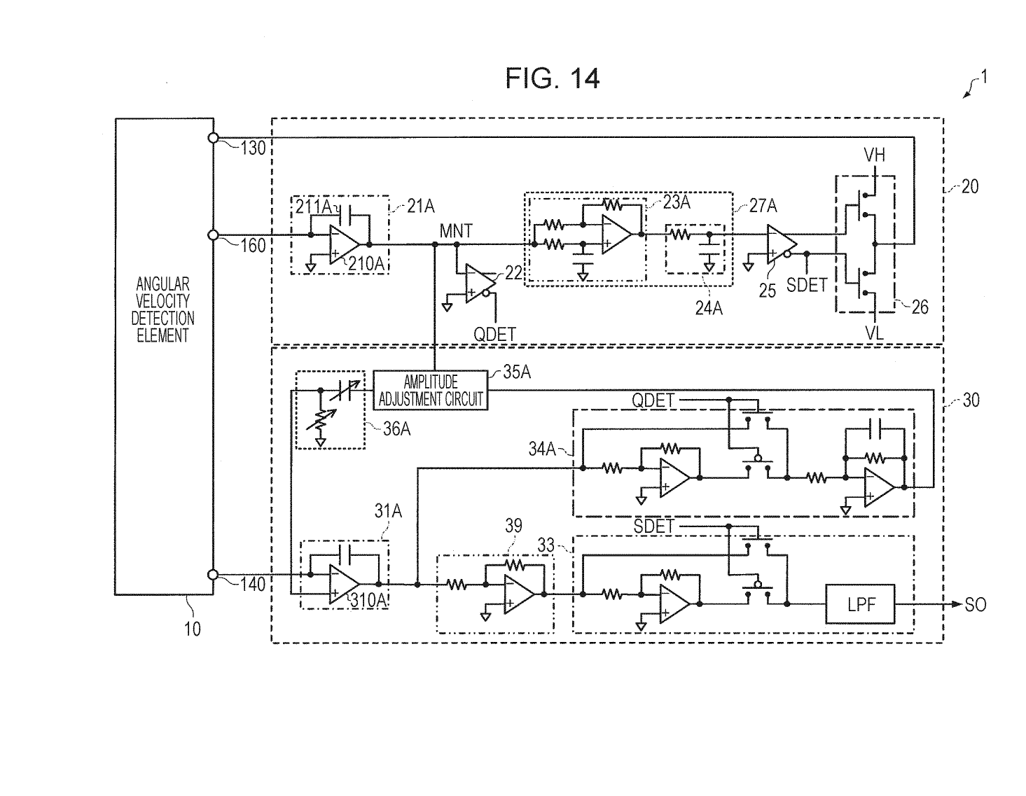

FIG. 14 illustrates a configuration of the angular velocity detection device 1 according to Modification Example 2 with respect to the angular velocity detection device 1 (FIG. 11) according to the third embodiment as an example. In the angular velocity detection device 1 according to Modification Example 2 in FIG. 14, the angular velocity detection element 10 is not provided with the stationary drive electrode 132, the stationary monitor electrode 162, and the stationary detection electrode 142. In correspondence with this configuration, the drive circuit 20 is not provided with the Q/V converter 21B and the phase adjustment unit 27B, and the configuration of the level conversion circuit 26 is also simplified. In addition, the angular velocity detection circuit 30 is not provided with the Q/V converter 31B, the quadrature synchronous detection circuit 34B, the amplitude adjustment circuit 35B, and the phase adjustment circuit 36B, and the differential amplifier 32 is substituted with an inverting amplifier 39.

According to the angular velocity detection device according to Modification Example 2, it is possible to exhibit the same effect as in the above-described embodiments.

### 2-3. Other Modification Examples

In the above-described embodiments, the phase of the quadrature correction signal may be retarded by 90°, and the Q/V converters 31A and 31B may be substituted with I/V converters. In addition, in the above-described embodiments, the amplitude adjustment circuits 35A and 35B may not be provided. In addition, in the above-described embodiments, a part of quadrature correction signals may be input to at least one of the inverting input terminal of the operational amplifier 310B and the inverting input terminal of the operational amplifier 310A through a capacitor.

### 3. ELECTRONIC APPARATUS

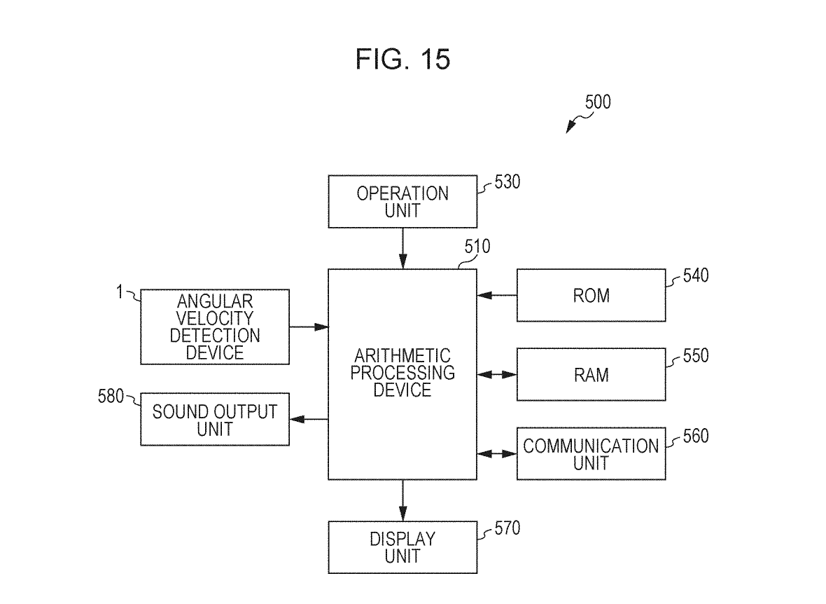

FIG. 15 is a functional block diagram of an electronic apparatus 500 according to this embodiment. Furthermore, the same reference numeral will be given to the same configuration as in the above-described embodiments, and description thereof will not be repeated.

The electronic apparatus 500 according to this embodiment is an electronic apparatus 500 including the angular velocity detection device 1. In an example illustrated in FIG. 15, the electronic apparatus 500 includes the angular velocity detection device 1, an arithmetic processing device 510, an operation unit 530, a read only memory (ROM) 540, a random access memory (RAM) 550, a communication unit 560, a display unit 570, and a sound output unit 580. Furthermore, in the electronic apparatus 500 according to this embodiment, a part of the constituent elements (respective units) illustrated in FIG. 15 may be omitted or changed, or a configuration to which other constituent elements are added may be employed.

The arithmetic processing device 510 performs various kinds of computation processing or control processing in accordance with a program that is stored in the ROM 540 and the like. Specifically, the arithmetic processing device 510 performs various kinds of processing corresponding to an output signal of the angular velocity detection device 1 or an operation signal transmitted from the operation unit 530, processing of controlling the communication unit 560 to make a data communication with the outside, processing of transmitting a display signal for displaying various pieces of information on the display unit 570, processing of outputting various kinds of sound on the sound output unit 580, and the like.

The operation unit 530 in an input device that is constituted by an operation key, a button switch, and the like, and outputs an operation signal corresponding to an operation by a user to the arithmetic processing device 510.

The ROM 540 stores a program or data for execution of various kinds of computation processing or control processing by the arithmetic processing device 510, and the like.

The RAM 550 is used as a work area of the arithmetic processing device 510, and temporarily stores a program or data which is read out from the ROM 540, data that is input from the operation unit 530, results obtained through computation executed by the arithmetic processing device 510 in accordance with various programs, and the like.

The communication unit 560 performs various controls for establishing a data communication between the arithmetic processing device 510 and an external device.

The display unit 570 is a display device that is constituted by a liquid crystal display (LCD), an electrophoresis display, and the like, and displays various pieces of information on the basis of a display signal that is input from the arithmetic processing device 510.

In addition, the sound output unit 580 is a device such as a speaker that outputs sound.

The electronic apparatus 500 according to this embodiment includes the angular velocity detection device 1 capable of further improving S/N of the angular velocity signal in comparison to the related art. Accordingly, it is possible to realize the electronic apparatus 500 capable of performing processing (for example, a control corresponding to a posture, and the like) based on a variation of an angular velocity with higher accuracy.

As the electronic apparatus 500, various electronic apparatuses may be considered. Examples of the electronic apparatus 500 include a personal computer (for example, a mobile type personal computer, a laptop type personal computer, and a tablet type personal computer), a mobile terminal such as a portable phone, a digital still camera, an ink jet type ejection device (for example, an ink jet printer), a storage area network device such as a router and a switch, a local area network apparatus, an apparatus for a mobile terminal base station, a television, a video camera, a video tape recorder, a car navigation device, a pager, an electronic organizer (also including one equipped with a communication function), an electronic dictionary, a calculator, an electronic gaming machine, a game controller, a word processor, a workstation, a videophone, a security television monitor, electronic binoculars, a point of sale (POS) terminal, a medical apparatus (for example, an electronic thermometer, a blood pressure meter, a blood glucose meter, an electrocardiogram measurement device, an ultrasonic diagnostic apparatus, and an electronic endoscope), a fish finder, various measurement apparatuses, meters (for example, meters of a vehicle, an aircraft, and a ship), a flight simulator, a head-mounted display, a motion tracer, a motion tracking device, a motion controller, a pedestrian dead reckoning (PDR) device, and the like.

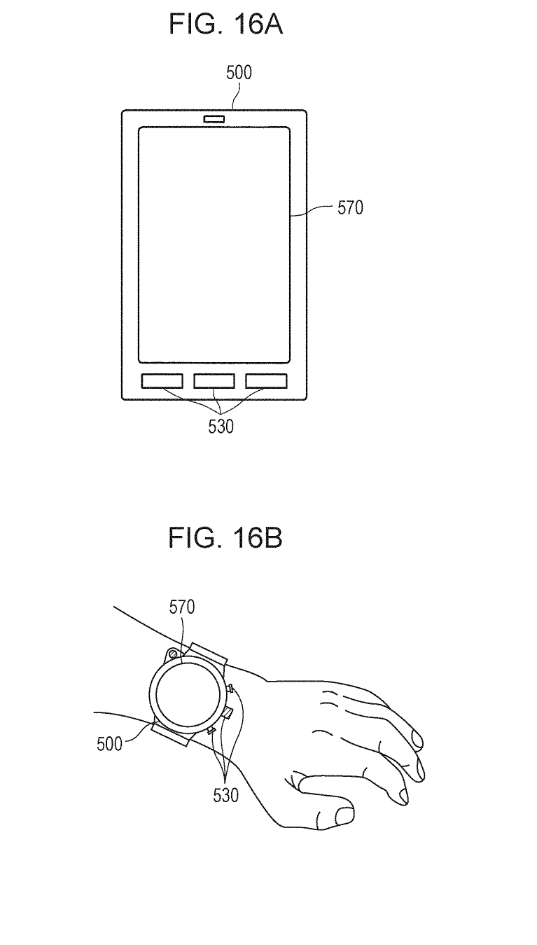

FIG. 16A is a view illustrating an example of an external appearance of a smart phone that is an example of the electronic apparatus 500, and FIG. 16B is a view illustrating an example of an external appearance of an arm-mounted portable apparatus as an example of the electronic apparatus 500. The smart phone that is the electronic apparatus 500 illustrated in FIG. 16A includes a button as the operation unit 530, and an LCD as the display unit 570. The arm-mounted portable apparatus that is the electronic apparatus 500 illustrated in FIG. 16B includes a button and a stem as the operation unit 530 and an LCD as the display unit 570. The electronic apparatus 500 includes the angular velocity detection device 1 capable of further improving S/N of the angular velocity signal in comparison to the related art. Accordingly, it is possible to realize the electronic apparatus 500 capable of performing processing (a display control corresponding to a posture, and the like) based on a variation of an angular velocity with higher accuracy.

### 4. MOVING OBJECT

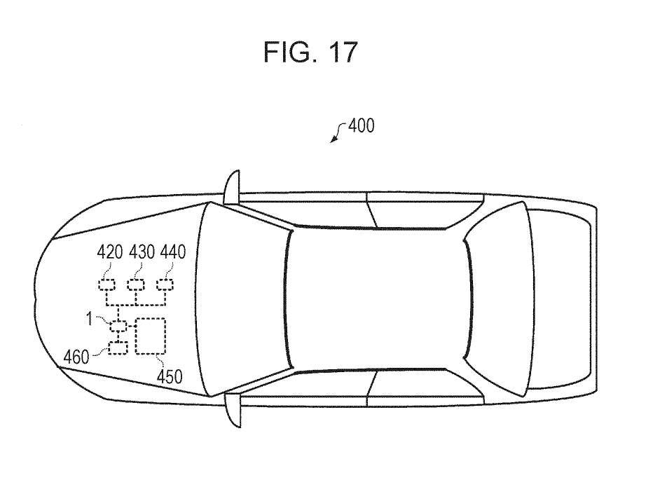

FIG. 17 is a view (top view) illustrating an example of a moving object 400 according to this embodiment. Furthermore, the same reference numeral will be given to the same configuration as in the above-described embodiments, and description thereof will not be repeated.

The moving object 400 according to this embodiment is a moving object 400 including the angular velocity detection device 1. In an example illustrated in FIG. 17, the moving object 400 includes a controller 420, a controller 430, and a controller 440 which perform various controls of an engine system, a brake system, a keyless entry system, and the like, a battery 450, and a backup battery 460. Furthermore, in the moving object 400 according to this embodiment, a part of the constituent element (respective units) illustrated in FIG. 17 may be omitted or changed, and a configuration to which other constituent elements are added may be employed.

The moving object 400 according to this embodiment includes the angular velocity detection device 1 capable of further improving S/N of the angular velocity signal in comparison to the related art. Accordingly, it is possible to realize the moving object 400 capable of performing processing (for example, a control of suppressing side slipping or overturning, and the like) based on a variation of an angular velocity with higher accuracy.

As the moving object 400, various moving objects may be considered, and examples thereof include a vehicle (also including an electric vehicle), an aircraft such as a jet airplane and a helicopter, a ship, a rocket, a satellite, and the like.

The invention is not limited to this embodiment, and can be executed by various modifications in a range of the gist of the invention.

The above-described embodiments and modification examples are illustrative only, and there is no limitation thereto. For example, the above-described embodiments and modification examples may be appropriately combined.

The invention includes substantially the same configuration (for example, a configuration in which a function, a method, and a result are the same, or a configuration in which an object and an effect are the same) as the configuration described in the embodiments. In addition, the invention includes a configuration in which substitution is made to portions that are not essential in the configuration described in the embodiments. In addition, the invention includes a configuration capable of exhibiting the same operational effect as in the configuration described in the embodiments or a configuration capable of achieving the same object. In addition, the invention includes a configuration in which a known technology is added to the configuration described in the embodiments.

The entire disclosure of Japanese Patent Application No: 2016-042346, filed Mar. 4, 2016 is expressly incorporated by reference herein.

What is claimed is:

1. An angular velocity detection circuit, comprising:
a first conversion unit that includes a first operational amplifier, and converts a first detection signal, which is output from a first detection electrode of an angular velocity detection element and is input to a first input terminal of the first operational amplifier, into a voltage;
an angular velocity signal generation unit that generates an angular velocity signal on the basis of an output signal of the first conversion unit; and
a first correction signal generation unit that generates a first correction signal for reducing an offset of the angular velocity signal which occurs due to a leakage signal that is included in the first detection signal on the basis of a signal based on drive oscillation of the angular velocity detection element,
wherein the first correction signal is input to the first input terminal or a second input terminal of the first operational amplifier directly or through a resistor.

2. The angular velocity detection circuit according to claim 1,
wherein the first correction signal generation unit includes a first amplitude adjustment unit that adjusts an amplitude of the first correction signal.

3. The angular velocity detection circuit according to claim 2,
wherein the first correction signal generation unit includes a first synchronous detection circuit that detects a level of the leakage signal included in the first detection signal on the basis of an output signal of the first conversion unit, and
the first amplitude adjustment unit adjusts the amplitude of the first correction signal on the basis of the level of the leakage signal which is detected by the first synchronous detection circuit.

4. The angular velocity detection circuit according to claim 2,
wherein the first amplitude adjustment unit adjusts the amplitude of the first correction signal on the basis of information that is stored in a storage unit.

5. The angular velocity detection circuit according to claim 1,
wherein phases of the first correction signal, and a Coriolis signal included in the first detection signal deviate from each other by 90°.

6. The angular velocity detection circuit according to claim 1,
wherein the first correction signal generation unit includes a first phase adjustment unit that adjusts a phase of the first correction signal.

7. The angular velocity detection circuit according to claim 6,
wherein the first correction signal generation unit includes a first synchronous detection circuit that detects a level of the leakage signal included in the first detection signal on the basis of an output signal of the first conversion unit, and
the first phase adjustment unit adjusts a phase of the first correction signal on the basis of the level of the leakage signal which is detected by the first synchronous detection circuit.

8. The angular velocity detection circuit according to claim 6,
wherein the first phase adjustment unit adjusts the phase of the first correction signal on the basis of information that is stored in a storage unit.

9. The angular velocity detection circuit according to claim 1, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

10. The angular velocity detection circuit according to claim 2, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

11. The angular velocity detection circuit according to claim 3, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

12. The angular velocity detection circuit according to claim 4, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

13. The angular velocity detection circuit according to claim 5, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

14. The angular velocity detection circuit according to claim 6, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

15. The angular velocity detection circuit according to claim 7, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

16. The angular velocity detection circuit according to claim 8, further comprising:
a second conversion unit that includes a second operational amplifier, and converts a second detection signal, which is output from a second detection electrode of the angular velocity detection element and is input to a first input terminal of the second operational amplifier, into a voltage; and
a second correction signal generation unit that generates a second correction signal for reducing an offset of the angular velocity signal which occurs due to a leakage signal that is included in the second detection signal on the basis of a signal based on the drive oscillation,
wherein the second correction signal is input to the first input terminal or a second input terminal of the second operational amplifier directly or through a resistor, and
the angular velocity signal generation unit includes a differential amplifier unit that differentially amplifies an output signal of the first conversion unit and an output signal of the second conversion unit, and generates the angular velocity signal on the basis of an output signal of the differential amplifier unit.

17. An angular velocity detection device, comprising:
the angular velocity detection circuit according to claim 1;
a drive circuit that drives the angular velocity detection element; and
the angular velocity detection element.

18. An electronic apparatus, comprising:
an angular velocity detection device according to claim 17.

19. A moving object, comprising:
the angular velocity detection device according to claim 17.
